(19) United States
(12) Patent Application Publication
(10) Pub. No.: US 2002/0001030 A1
(43) Pub. Date: Jan. 3, 2002

(54) Three-dimensional display apparatus and oblique projection optical system

(75) Inventors: Manami Kuiseko, Kyoto-shi (JP); Makoto Miyazaki, Osaka (JP); Ken Yoshii, Itami-shi (JP)

Correspondence Address: McDERMOTT, WILL & EMERY, 600 13th Street, N.W., Washington, DC, 20005, US

(73) Assignee: MINOLTA CO., LTD.

(21) Appl. No.: 09/860,463

(22) Filed: May 21, 2001

(30) Foreign Application Priority Data
May 26, 2000 (JP) P2000-156908

(51) Int. Cl. H04N 13/04; H04N 15/00

(52) U.S. Cl. 348/51

(57) ABSTRACT

An oblique projection optical system is provided with a first group lens system, a second group lens system and a third group lens system that are placed in succession from a short conjugate length focal surface, and each lens system has a plurality of single lenses. The first group lens system contains a beam regulator to form a telecentric structure. The second group lens system is set to have a great tilt decentration and a parallel decentration with respect to the first group lens system. The third group lens system is set to have a great tilt decentration and a parallel decentration with respect to the second group lens system. In this manner, instead of making the lenses decentered inside each lens system, the respective lens systems are made decentered from each other; thus, the resulting projection device is easily manufactured, and makes it possible to correct the distortion aberration and focal position on the screen surface, and to project an image with high precision. Therefore, it becomes possible to display a three-dimensional image with high precision.

This application is based on application No. 2000-156908 filed in Japan, the contents of which are hereby incorporated by reference.

### BACKGROUND OF THE INVENTION

1. Field of the Invention

The present invention relates to a three-dimensional display apparatus which has a surface for providing a basic image and a screen surface which is allowed to rotate around a predetermined axis and on which the provided basic image is projected, and also concerns an oblique projection optical system installed therein.

2. Description of the Background Art

Conventionally, there has been proposed a projection apparatus in which oblique projection optical system is installed so that an image is projected onto a stationary screen placed in a vertical plane obliquely from below so as to be displayed thereon. In such a device, the oblique projection optical system is provided with a decentering lens which focuses the image on the entire surface of the screen.

In recent years, a projection apparatus has been developed in which an image is projected on a screen while the screen is being rotated around a vertical axis so that the image is displayed three-dimensionally by utilizing its after images, and in such an apparatus, the image is projected obliquely from below so as to prevent the projection optical system from disturbing the viewing field. For this reason, the image projected on the screen is susceptible to distortional aberration and focus offset, with the result that the device tends to fail to provide a three-dimensional image with precision.

Here, the conventional oblique projection optical system is only allowed to have a tilt angle of 20° at most. Therefore, when this is applied to the above-mentioned three-dimensional display apparatus, it is difficult to arrange this in a manner so as not to disturb the viewing field.

### SUMMARY OF THE INVENTION

The present invention is directed to a three-dimensional display apparatus.

In one aspect of the present invention, the three-dimensional display apparatus is provided with: a screen; a rotation mechanism for rotating the screen so as to volume-scan a predetermined space; an image generation section for generating a cross-sectional image of a three-dimensional object to be displayed in response to a rotation of the rotation mechanism and for providing the cross-sectional image; and a projection optical system for correcting distortion and out-of focus on a surface of the screen of the cross-sectional image provided from the image generation section, and for projecting the cross-sectional image to the screen that is rotating. Therefore, the apparatus makes it possible to display a three-dimensional image with high precision.

In another aspect of the present invention, the three-dimensional display apparatus is arranged such that the projection optical system projects the cross-sectional image to the screen from a position that is rotated by the rotation mechanism while maintaining a positional relationship with the screen. Therefore, there are no parts shielding the front side of the screen so that it becomes possible to provide better visibility to the screen.

Moreover, the present invention is also directed to oblique optical system in which a line, which optically connects a center of a short conjugate length focal surface that is a focal surface on a short conjugate length side and a center of a long conjugate length focal surface that is a focal surface on a long conjugate length side, is allowed to have an angle other than vertical with respect to the long conjugate length focal surface.

Therefore, the objective of the present invention is to provide a three-dimensional display apparatus which can display a three-dimensional image with precision and oblique projection optical system that is suitably applied to such a projection apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing that schematically shows the appearance of a three-dimensional image display apparatus in accordance with a preferred embodiment;

FIG. 2 is a drawing that shows the structure of an optical system in the three-dimensional image display apparatus;

FIG. 3 is a schematic perspective view that shows one example of a screen and a rotation member;

FIG. 4 is a drawing that shows a size of a cross-sectional image to be projected onto the screen;

FIG. 5 is a drawing that shows the structure of a color filter in accordance with the preferred embodiment;

FIG. 6 is a drawing that schematically shows an image generation surface of a DMD;

FIG. 7 is a drawing that specifically shows an intermediate optical system that is shown in FIG. 2;

FIG. 8 is a drawing that schematically shows the structure of oblique projection optical system together with the DMD and the screen;

FIG. 9 is a drawing that shows a light path of the oblique projection optical system of a first example;

FIG. 10 is a drawing that shows a point spread on the screen surface of the oblique projection optical system of the first example;

FIG. 11 is a drawing that shows a light path of the oblique projection optical system of a second example;

FIG. 12 is a drawing that shows a point spread on the screen surface of the oblique projection optical system of the second example;

FIG. 13 is a drawing that shows a light path of the oblique projection optical system of a third example;

FIG. 14 is a drawing that shows a point spread on the screen surface of the oblique projection optical system of the third example;

FIG. 15 is a drawing that shows a light path of the oblique projection optical system of a fourth example;

FIG. 16 is a drawing that shows a point spread on the screen surface of the oblique projection optical system of the fourth example;

FIG. 17 is a drawing that shows a light path of the oblique projection optical system of a fifth example;

FIG. 18 is a drawing that shows a point spread on the screen surface of the oblique projection optical system of the fifth example;

FIG. 19 is a drawing that shows a light path of the oblique projection optical system of a sixth example;

FIG. 20 is a drawing that shows a point spread on the screen surface of the oblique projection optical system of the sixth example;

FIG. 21 is a drawing that shows a light path of the oblique projection optical system of a seventh example; and

FIG. 22 is a drawing that shows a point spread on the screen surface of the oblique projection optical system of the seventh example.

### DESCRIPTION OF THE PREFERRED EMBODIMENTS

Referring to Figures, the following description will discuss preferred embodiments of the present invention.

<A. Three-dimensional display apparatus>

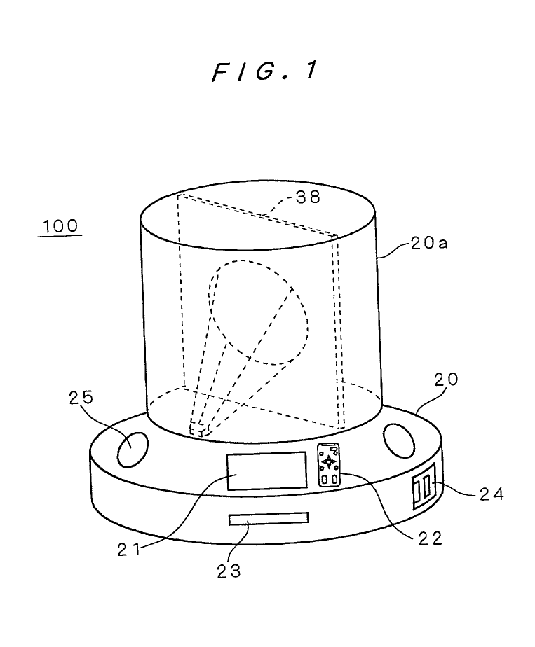

An explanation will be given of a three-dimensional image display apparatus 100 which is one preferred embodiment of a projection apparatus of the present invention. FIG. 1 is a drawing that schematically shows the appearance of the three-dimensional display apparatus 100. This three-dimensional image display apparatus 100 is provided with a housing 20 containing an optical system for projecting a cross-sectional image on a screen 38 and a control mechanism for carrying out various kinds of data processing and a cylinder-shaped windshield 20a that is installed on the upper side of the housing 20, and contains a rotating screen therein.

The windshield 20a is made of a transparent material such as glass and acrylic resin, and designed so that a cross-sectional image projected on the screen 38 rotating inside thereof is viewed from outside. Moreover, the windshield 20a shields the inner space in such a manner that the rotation of the screen 38 is stabilized and the power consumption of the motor used for rotative driving operation is reduced.

On the front face side of the housing 20, a liquid crystal display (LCD) 21, an operation switch 22 that is detachably attached thereto and an attaching inlet 23 for a recording medium 4 are placed, and on the side face thereof, a digital input-output terminal 24 is installed. The liquid crystal display 21 is used as a display means for an operation guiding screen used for receiving operational inputs as well as for a two-dimensional image used for an index of a display subject. The digital input-output terminal 24 includes terminals such as an SCSI terminal and an IEEE 1394 . Moreover, speakers 25 used for sound output are placed at four portions on the outer circumferential face of the housing 20.

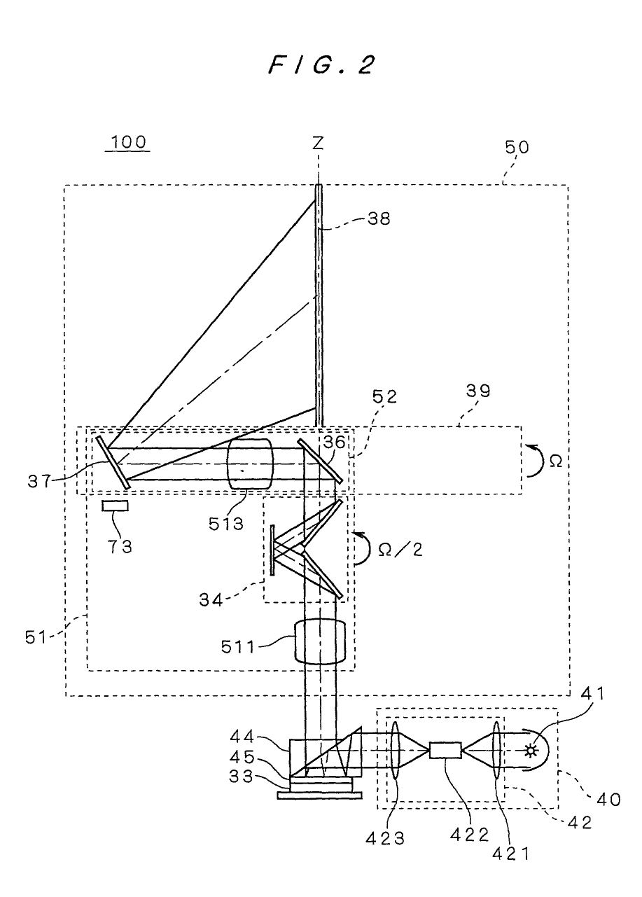

Next, an explanation will be given of an optical system for projecting a cross-sectional image on the screen 38 in the three-dimensional display apparatus 100. FIG. 2 is a drawing that shows a construction including an optical system in the three-dimensional image display apparatus 100. As illustrated in FIG. 2, this optical system in the three-dimensional image display apparatus 100 is provided with an illuminating optical system 40, a process and projection optical system 50, a DMD (digital-micromirror-device) 33, a TIR prism 44, a cover glass (not shown) and a color filter 45. Here, the cover glass is installed on a face of the TIR prism 44 that contacts the color filter 45, and this is depicted only in an example that will be described later.

First, an explanation will be given of the DMD 33. The DMD 33 and the color filter 45 function as an image generation means for generating a cross-sectional image to be projected onto the screen 38, and the DMD 33 has a structure in which minute mirrors, each of which is made of a metal piece (for example, aluminum piece) having a rectangular shape one side of which is approximately 16 μm, and serves as a pixel, are affixed on a plane in a scale having several hundred thousands of pieces per chip, and this device is controlled by an electrostatic field function of the output of SRAMs placed right under the respective pixels so that the tilt angle of each mirror is changed within the range of ±10 degrees. Here, the mirror angle is ON/OFF controlled in a binary manner in response to “1” and “0” of the SRAM output, and upon receipt of light from a light source, only light reflected by those mirrors aligned in the ON (OFF) direction is allowed to proceed toward the process and projection optical system 50, while light reflected by those mirrors aligned in the OFF (ON) direction is directed out of the effective light path, and is not allowed to reach the process and projection optical system 50. This ON/OFF control of the mirrors generates a cross-sectional image corresponding to the distribution of ON/OFF mirrors, and this image is projected on the screen 38.

Here, the tilt angle of each mirror is controlled so as to switch the direction of the reflected light, and by adjusting this switching time (the length of reflection time), it is possible to express the density (gradation) of each pixel, and consequently to express 256 gradations for each color.

The DMD 33 of this type has two major advantages; that is, first it has a high efficiency of use of light, and second, it has a high-speed responsivity. In general, this is applied to a video projector, etc., by utilizing its high efficiency of use of light.

In the present preferred embodiment, by utilizing the other major advantage of the DMD 33, that is, the high-speed responsivity, it is possible to display even a moving image of a display subject by using a volume scanning method utilizing after-image effects.

Since the responsivity of deflection of each mirror is approximately 10 μsec and since the writing operation for image data is carried out in the same manner as the generally-used SRAM, the DMD 33 makes it possible to provide an image at a very high speed, for example, 1 msec or less. Supposing that the speed is 1 msec, in the case when a volume scanning process of 180° at 1/18second (that is, 9 revolutions per second) is carried out so as to achieve after-image effects, the number of cross-sectional images that can be generated is approximately 60. In comparison with a CRT, a liquid crystal display, etc., that is conventionally used as an image generation means for the volume scanning method, the DMD 33 makes it possible to project much more cross-sectional images on the screen 38 per unit time, and consequently to display not only a three-dimensional object having a non-rotation symmetric shape but also a moving image.

Moreover, the other advantage of the DMD 33, that is, the high efficiency of use of light, devotes to improve the after-image effects by projecting lighter cross-sectional images on the screen 38, thereby making it possible to display a three-dimensional image with higher quality as compared with the CRT system, etc.

Here, as illustrated in FIG. 2, on the image generation face side of the DMD 33, a color filter 45 having divided areas for respective color components is placed, and the DVD 33 generates a plurality of cross-sectional images (projection images) corresponding to the respective color components for the areas. On the image generation face side of the DMD 33, a TIR prism 44, which directs illuminated light from the illuminating optical system 40 to the minute mirrors through the color filter 45, and also directs the plurality of cross-sectional images for the respective color components generated by the DMD 33 to the process and projection optical system 50, is placed.

The illuminating optical system 40 is provided with a white light source 41 and an illuminating lens system 42, and illuminating light from the white light source 41 is formed into parallel light rays by the illuminating lens system 42. The illuminating lens system 42 is constituted by a condenser lens 421, an integrator 422 and a relay lens 423. The illuminating light from the white light source 41 is converged by the condenser lens 421, and made incident on the integrator 422. Then, the illuminating light, which is allowed to have a uniform distribution in quantity of light by the integrator 422, is formed into parallel light rays by the relay lens 423, made incident on the TIR prism 44, and then directed on the DMD 33 through the color filter 45.

Based upon two-dimensional image data given by a host computer, etc., not shown, the DMD 33 changes the tilt angle of each minute mirror so that only some light components of the illuminating light required for projecting the cross-sectional images are reflected toward the process and projection optical system 50.

The process and projection optical system 50 is provided with a process and projection lens system 51 and a screen 38. This process and projection lens system 51 is provided with an intermediate optical system 511, oblique projection optical system 513 and projection mirrors 36, 37 and an image rotation compensating mechanism 34. Among these, the oblique projection optical system 513 and the projection mirrors 36, 37 constitute a rotation optical system 52, which is placed inside a rotation member 39 that allows the screen 38 to rotate around a rotary axis Z.

The light (cross-sectional image) reflected by the DMD 33 is formed into parallel light rays by the intermediate optical system 511, and allowed to pass through the image rotation compensating mechanism 34 so as to be subjected to a rotation compensation for the cross-sectional image. The light rays that have been subjected to the rotation compensation in the image rotation compensating mechanism 34 are allowed to pass through the projection mirror 36, the oblique projection optical system 513 and the projection mirror 37, and then finally projected onto a main surface (projection surface) of the screen 38. Therefore, the process and projection optical system 50 and the DMD 33 constitute a projection image generation element which successively generates a plurality of cross-sectional images based upon two-dimensional image data, and successively projects the cross-sectional images on the screen in synchronism with the rotative scanning of the screen 38.

In this optical system, the projection mirror 36, the oblique projection optical system 513, the projection mirror 37 and the screen 38 are fixed onto the rotation member 39, and these are rotated around the vertical rotary axis Z including the center axis of the screen 38 at an angular velocity of Ω, as the rotation member 39 rotates. In other words, upon rotating the screen 38 so as to carry out the volume scanning, the projection mirror 36, the oblique projection optical system 513 and projection mirror 37 placed inside the rotation member 39 are rotated integrally with the screen 38; therefore, independent of the angle of the screen 38, the projection of the cross-sectional images is always carried out from the front side.

Here, the rotation angle of the screen 38 is always detected by a position detector 73.

Thus, the cross-sectional images, generated by the DMD 33, are projected on the screen 38. The function of the oblique projection optical system 513 is to allow the light rays to form an appropriate image size before reaching the screen 38. Moreover, the projection mirror 37 is placed in such a position that it projects the cross-sectional images onto screen 38 from the position obliquely below on the front side thereof (from the inner side of the rotation member 39 in the case of FIG. 2) so as not to disturb the viewing field of the viewer upon observing the three-dimensional image projected onto the screen 38. Here, the positional order of the oblique projection optical system 513 with respect to the projection mirrors 36 and 37 is not intended to be limited by the present preferred embodiment.

Here, an explanation will be given of the image rotation compensating mechanism 34. The image rotation compensating mechanism 34, shown in FIG. 2, is realized by the structure of a so-called image rotator. When the rotation member 39 to which the screen 38 is attached is located with a certain rotation angle, a cross-sectional image projected on the screen 38 is set as a reference image. Supposing that no image rotation compensating mechanism 34 is used, the cross-sectional images being projected are in-plane rotated on the screen 38 as the rotation member 39 rotates, with the result that a cross-sectional image that is projected when the rotation member 39 has rotated 180° is given as an upside-down reversed image with respect to the reference image. The image rotation compensating mechanism 34 is used to prevent this phenomenon.

The image rotation compensating mechanism 34, shown in FIG. 2, uses an image rotator constituted by a plurality of mirrors combined therein. When the image rotator is rotated around the light axis, it has such a function that, in response to an incident image, a released image is allowed to rotate with an angular velocity twice as fast as the angular velocity of the image rotator. Therefore, by rotating the image rotor at an angular velocity of ½of that of the rotation member 39 to which the screen 38 is attached, it becomes possible to always project an erecting cross-sectional image independent of the rotation of the screen.

Here, with respect to the image rotation compensating mechanism, besides the image rotator, a Dove (type) prism may be used with the same effects. Moreover, instead of using the image rotation compensating mechanism 34 used here, the cross-sectional image to be generated on the surface of the DMD 33 may be formed as an image rotating around the light axis in accordance with the rotation angle of the screen 38 so that the rotation of the projected image may be cancelled.

In other words, the two-dimensional image data for generating the cross-sectional image may be corrected at a stage before being given to the DMD 33 in such a manner that the resulting cross-sectional image generated on the surface of the DMD 33 is formed as an erecting image (or an inverted image) at the start of the volume scanning, and with the rotation of the screen 38, it rotates to form an inverted image (or an erecting image) upon completion of the volume scanning.

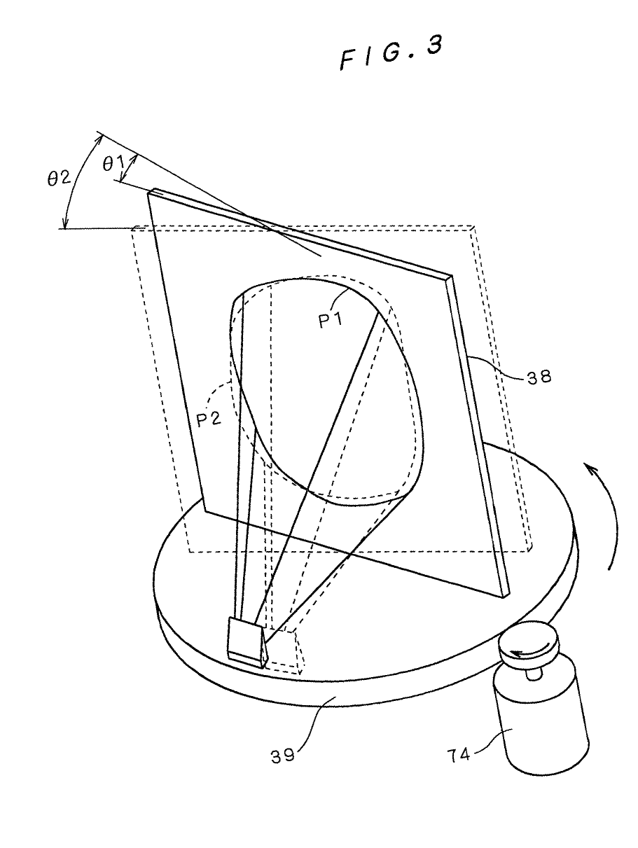

FIG. 3 is a schematic perspective view that shows one example of the screen 38 and the rotation member 39. As illustrated in FIG. 3, the rotation member 39 has a disc shape, and the rotary shaft of a motor 74 serving as a rotative driving element is made in contact with the side face thereof so that it is driven to rotate. Here, a motor may be directly connected to the center axis of the rotation member 39, or this may be driven by an element of gears and belts.

As illustrated in FIG. 3, when the screen 38 is located with a rotation angle θ1, a cross-sectional image P1 (generated by the DMD 33) of the display subject corresponding to θ1 is projected onto the screen 38 through the projection mirror 36, the oblique projection optical system 513 and the projection mirror 37 shown in FIG. 2. After a lapse of an instantaneous time, the screen 38 is rotated, and when the rotation angle becomes θ2, a cross-sectional image P2 (generated by the DMD 33) of the display subject corresponding to θ2 is projected onto the screen 38 through the projection mirror 36, the oblique projection optical system 513 and the projection mirror 37 shown in FIG. 2.

The projection mirror 36, the oblique projection optical system 513 and the projection mirror 37 are commonly rotated with a fixed positional relationship with respect to the screen 38; thus, a cross-sectional image is always projected onto the screen 38 independent of the rotation thereof. Here, at the time when the rotation member 39 has been rotated 180° (or 360°), the same cross-sectional image as the starting image appears, thereby completing one volume scanning operation. When the above-mentioned processes are carried out with a sufficiently high speed of the rotation member 39 so as to cause the after-image effect, and when the number of the cross-sectional images to be projected is sufficiently increased, the viewer is allowed to observe a three-dimensional image of the display subject as an envelop of the cross-sectional images.

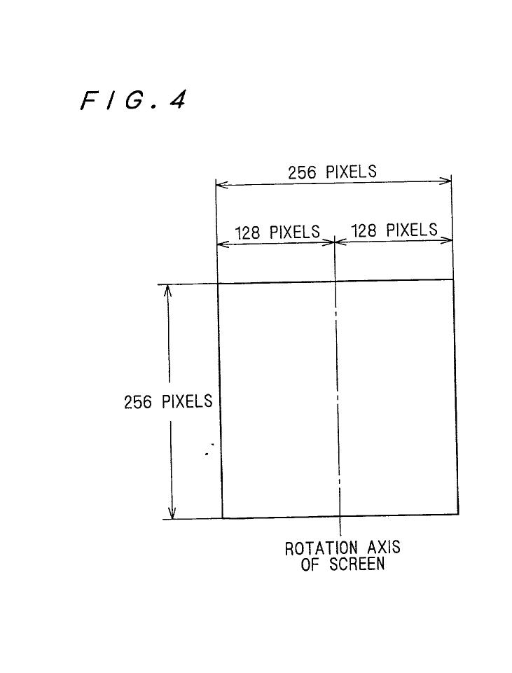

Next, an explanation will be given of the size (resolution) of the cross-sectional image. FIG. 4 is a drawing that shows a size of the cross-sectional image to be projected onto the screen 38. The cross-sectional image has a size of 256 pixels (horizontal direction)×256 pixels (vertical direction), and is projected symmetrically with respect to the rotation axis of the screen 38. In other words, the size consists of 128 pixels on each of the right and left sides in the circumferential direction with the rotation axis located in the center. The cross-sectional image thus projected is commonly rotated with a fixed relationship with respect to the screen 38 so that independent of the rotation of the screen 38, the size of the projected cross-sectional image is constant. Here, the size of the cross-sectional image shown in FIG. 4 is simply given as one example; and this may be set to a desired size depending on the number of minute mirrors installed on the DMD 33 to be used.

<B. Construction for color display>

An explanation will be given of a construction for carrying out a color display in the present preferred embodiment. A color filter 45 is divided into a plurality of areas so that each of the areas is allowed to transmit any one of color components of, for example, R(red), G(green) and B(blue). The divisions into the three color components of R, G and B make it possible to color-display the cross-sectional images on the screen 38.

In order to provide a color display, the following methods are proposed: as conventionally used, with respect to illuminating light to be applied to the DMD, R component, G component and B component are generated in a time-divided manner; and three DMDs are prepared and in each of the DMDs, a cross-sectional image corresponding to each of R component, G component and B component is generated. However, in the former method, since three cross-sectional images corresponding to R, G and B are projected so as to form one color cross-sectional image, a display time of three times as long is required. Moreover, in the latter method, the three DMDs are required with the result that the costs become high.

The present preferred embodiment provides a construction in which one DMD 33 is divided into plurality of areas corresponding to R, G and B so that a projection time for one color image can be shortened and a color display is available at low costs.

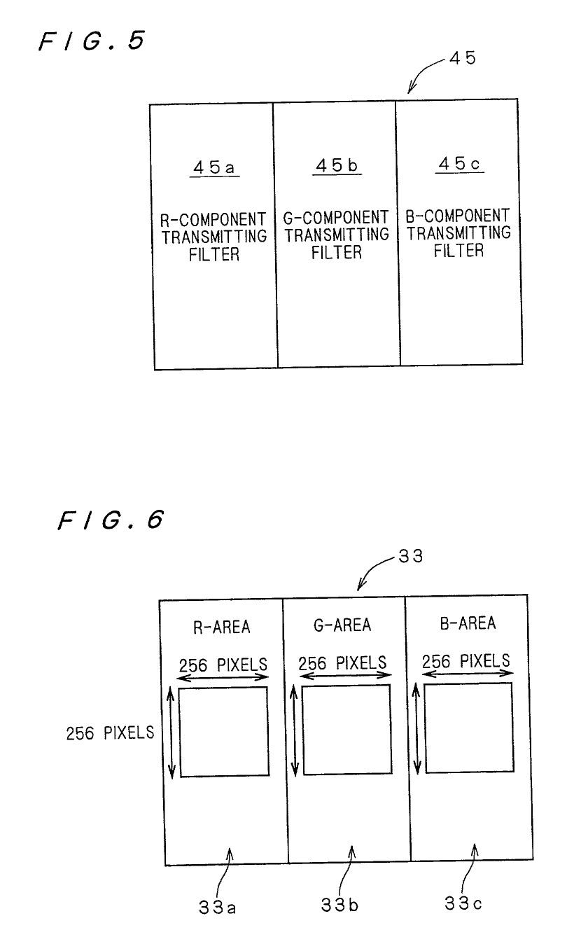

FIG. 5 shows the structure of a color filter 45 in accordance with the present preferred embodiment. In the present preferred embodiment, the color filter 45 as shown in FIG. 5 is used. As illustrated in FIG. 5, the color filter 45 is divided into three areas, that is, a filter portion 45a for transmitting light of R component, a filter portion 45b for transmitting light of G component and a filter portion 45c for transmitting light of B component. The divisions of the color filter 45 into respective areas corresponding to the number of color components can be easily achieved at low costs. Further, as illustrated in FIG. 5, the color filter 45, thus divided into the respective areas, is placed on the image generating surface side of the DMD 33.

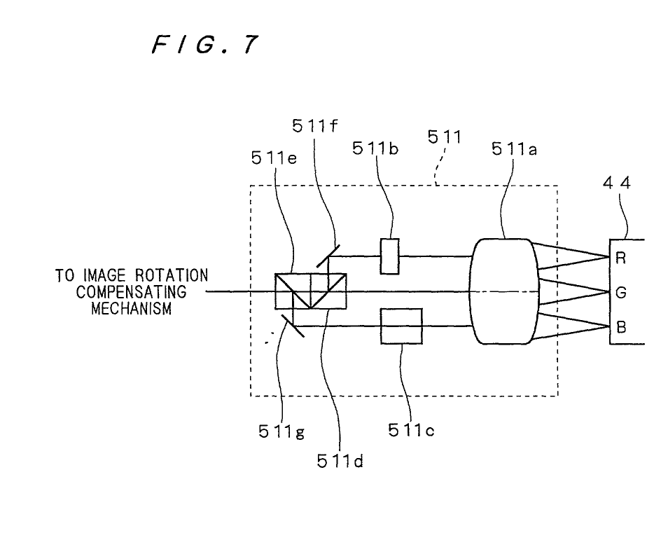

FIG. 6 is a drawing that schematically shows the image generating surface of the DMD 33. By placing the color filter shown in FIG. 5 on the DMD 33, the image generating surface of the DMD 33 is divided into three areas 33a, 33b and 33c. The area 33a is an area for receiving light of R component through the color filter 45, the area 33b is an area for receiving light of G component, and the area 33c is an area for receiving light of B component. In other words, in the present preferred embodiment, not defining color components for the respective pixels, areas corresponding to respective color components are defined as a two-dimensional continuous array of pixels as shown in FIG. 6.

Then, in the case when, as shown in FIG. 4, a cross-sectional image of 256 pixels×256 pixels is projected onto the screen 38, as illustrated in FIG. 6, a generation of a cross-sectional image corresponding to each of the color components is carried out on an image generation portion of 256 pixels×256 pixels that is located virtually in the center of each of the areas 33a, 33b and 33c on the DMD 33. Here, in the case when the DMD 33 is provided with a great number of pixels (the number of minute mirrors), distances between the image generation portion of the area 33a and the image generation portion of the area 33b as well as between the image generation portion of the area 33b and the image generation portion of the area 33c are set to be sufficiently wider; therefore, it is possible to easily carry out a job for placing the color filters 45 onto the DMD 33. In other words, in the case when the image generation portions of the respective areas 33a to 33c are not adjacent to each other, even when the installation position at the time of placing the color filters 45 is slightly offset, the offset will not cause light of another color component to enter the image generation portion; therefore, it is possible to generate a cross-sectional image of each of the color components without causing any problem.

In other words, in the present preferred embodiment, an image generation element, constituted by the DMD 33 and the color filters 45, is provided with a plurality of areas that are respectively defined as a two-dimensional continuous array of pixels by dividing an integrally formed pixel array surface, and a plurality of cross-sectional images corresponding to respectively different color components are simultaneously generated at the respective areas; thus, it is possible to generate the cross-sectional images corresponding to the respective color components required for providing colors to a three-dimensional image to be projected onto the screen 38. Therefore, it becomes possible to carry out a color display by using a simple structure comparatively with ease at low costs. Moreover, in the case when the respective color components are the three color components of R, G and B, since three times as many cross-sectional images as the case for providing a color display in a time-divided manner are projected, it is possible to provide a projected three-dimensional image with high precision. Furthermore, in the case when the color display is carried out in a time divided manner, a driving section, etc., for rotating a rotary color filter is required; in contrast, in the arrangement as described in the present preferred embodiment, the DMD 33 is divided into a plurality of areas, and cross-sectional images corresponding to the respective color components are simultaneously generated at the respective areas. Since this arrangement eliminates the necessity of installing any specific driving section, etc., for carrying out a color display, it becomes possible to miniaturize the construction for carrying out a color display.

Next, an explanation will be given of the intermediate optical system 511. FIG. 7 is a drawing that shows the intermediate optical system 511 shown in FIG. 2 in detail. In the case when cross-sectional images are generated for the respective components of R, G and B in the different areas as described above, these cross-sectional images need to be composed into one image during a process in which they are projected onto the screen 38. Through this process, one color image is formed.

For this reason, the intermediate optical system 511 is provided with telecentric optical systems 511a on both sides, light path length adjusting devices 511b, 511c, dichroic mirrors 511d, 511e and mirrors 511f, 511g, and the cross-sectional images corresponding to the respective color components generated in the areas 33a to 33c of FIG. 6 are composed onto one light path.

Respective light rays (cross-sectional images) of R component, G component and B component, which have been generated on the respective areas of the DMD 33, are allowed to pass through the TIR prism 44, and formed into parallel light rays by the telecentric optical systems 511a on both sides. Then, the light rays of respective components of R, G and B (cross-sectional images), formed into the parallel light rays, form respectively different three light paths. For example, as illustrated in FIG. 7, the light ray of R component is allowed to pass above the light ray of G component, and the light ray of B component is allowed to pass below the light ray of G component; thus, three parallel light rays are formed.

Then, the light ray of R component, which has been formed into parallel light, is made incident on the light path length adjusting device 511b, where this is subjected to a compensating process for a light-path difference caused between it and the cross-sectional image of G component, and this is then entirely reflected by the mirror 511f, and composed by the dichroic mirror 511d with the light ray of G component passing through it.

Moreover, the light ray of B component, which has been formed into parallel light, is also made incident on the light path length adjusting device 511c, where this is subjected to a compensating process for a light-path difference caused between it and the cross-sectional image of G component, and this is then entirely reflected by the mirror 511g, and composed by the dichroic mirror 511e with the light rays of R component and G component.

As illustrated in FIG. 2, the composed light derived from the light rays of the respective color components is projected onto the screen 38 through the image rotation compensating mechanism 34, the projection mirror 36, the oblique projection optical system 513 and the projection mirror 37.

In this manner, even in the case when cross-sectional images corresponding to the respective components of R, G and B are generated in the different areas on the DMD 33, these cross-sectional images are composed into one image during a process in which they are projected onto the screen 38; thus, it is possible to properly project one color-displayed cross-sectional image on the screen 38.

<C. Oblique Projection Optical System>

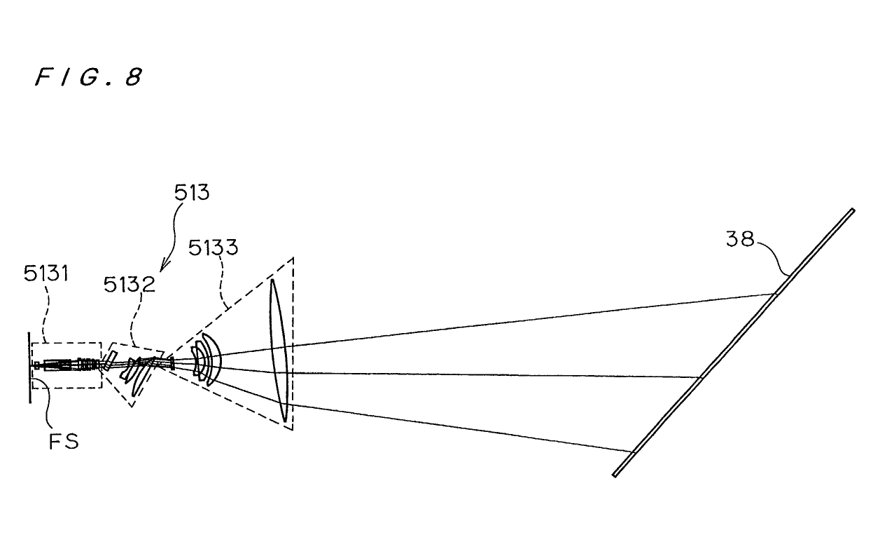

FIG. 8 is a drawing that shows the schematic structure of the oblique projection optical system together with the DMD 33 and the screen 38. Here, in FIG. 8, the detailed lens structures of the respective lens systems are simply given as examples; and they are not necessarily the same as the detailed structures of respective examples which will be described below. Moreover, in FIG. 8, the projection mirror 37 is omitted, and this Figure shows a short conjugate length focal surface FS serving as a conjugate face with the display surface, in which the display surface of the DMD 33 is relayed by the projection mirror 36, the image rotation compensating mechanism 34, the intermediate optical system 511, the TIR prism 44, etc. Therefore, the following description given with respect to the short conjugate length focal surface FS is also equivalent to the display surface of the DMD 33.

The oblique projection optical system 513 has an arrangement in which the line optically connecting the center of the short conjugate length focal surface and the center of the long conjugate length focal surface (screen surface) is allowed to have any angle except for vertical with respect to the long conjugate length focal surface, and is provided with a first group lens system 5131, a second group lens system 5132 and a third group lens system 5133 that are aligned in this order from the short conjugate length focal surface FS, and each lens system contains a plurality of single lenses. Moreover, the third group lens system 5133 is allowed to face the screen face (long conjugate length focal surface) with a predetermined angle through the projection mirror.

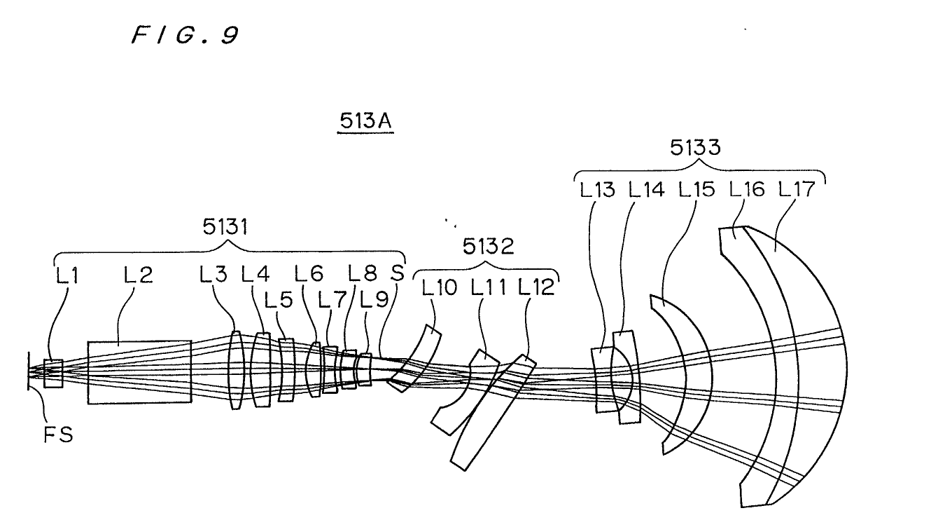

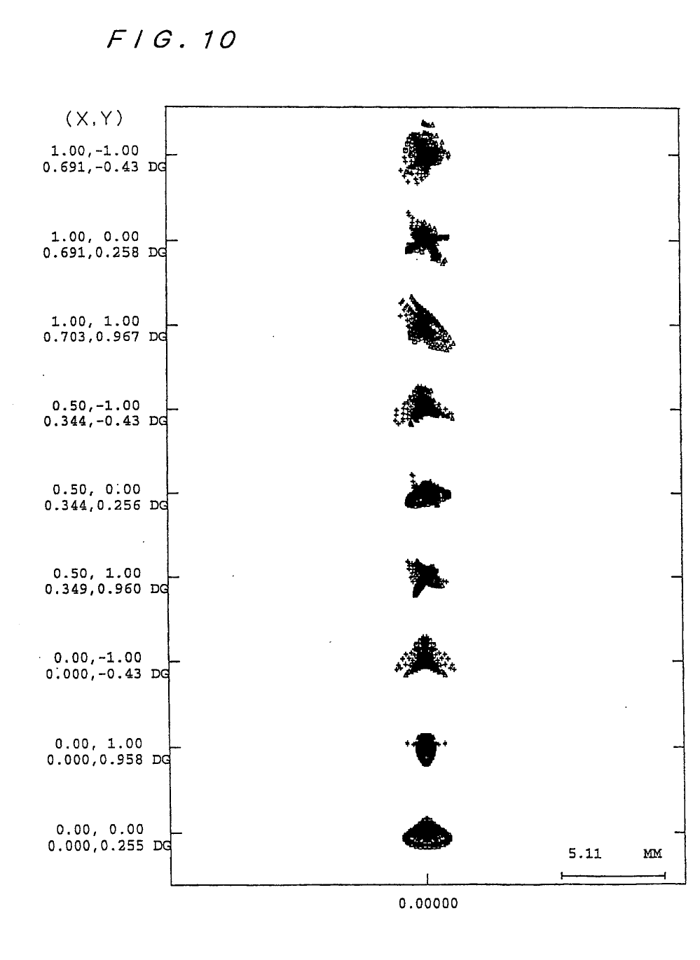

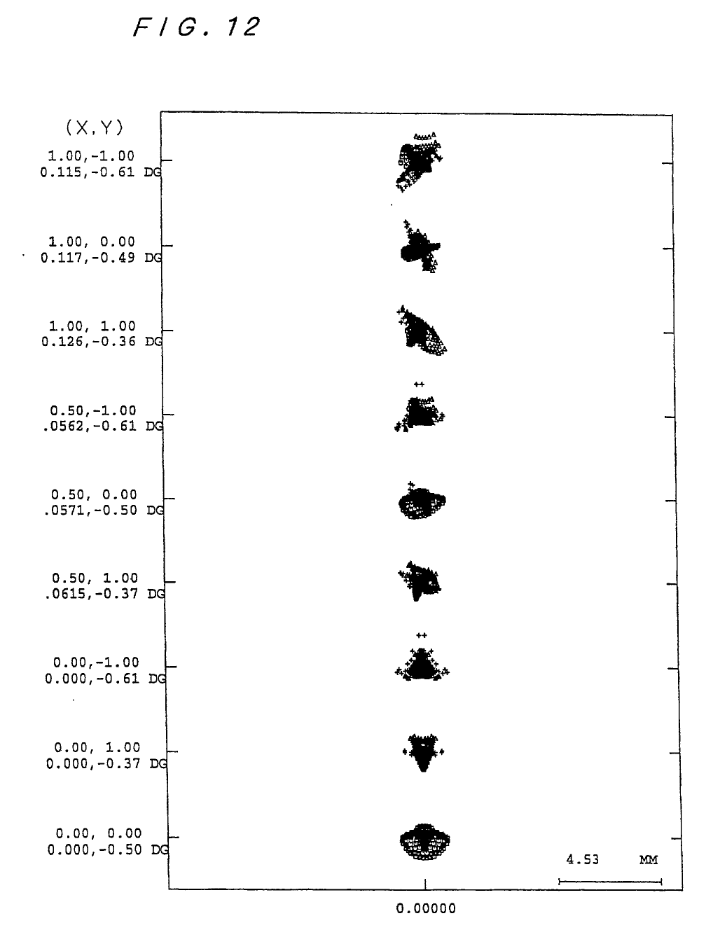

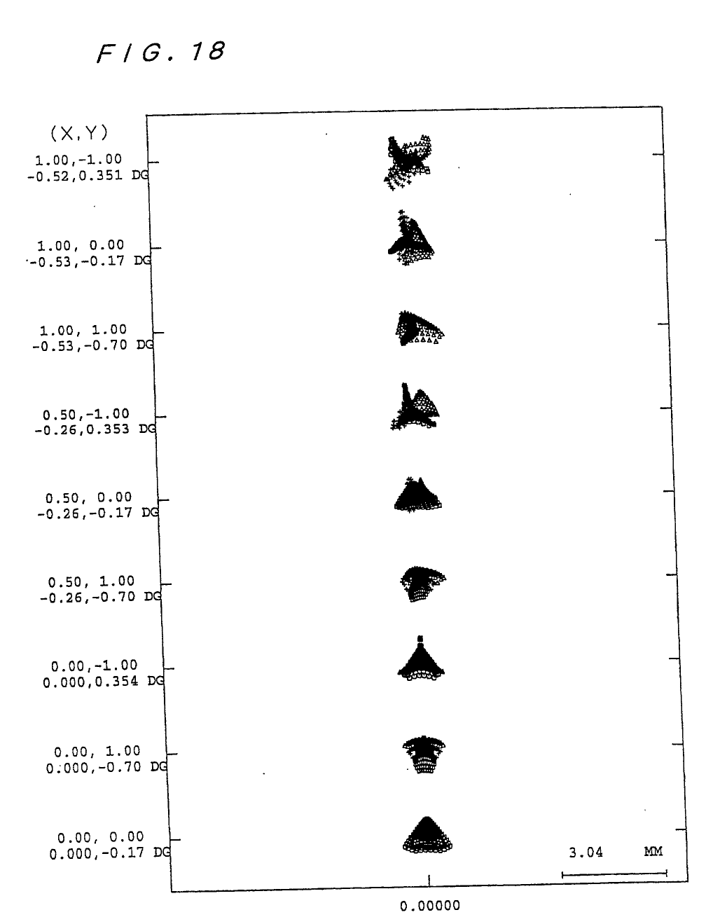

Here, the respective lens systems have the following schematic structures (see FIG. 9, FIG. 11, FIG. 13, FIG. 15, FIG. 17, FIG. 19 and FIG. 21).

The first group lens system 5131, which contains a beam regulator such as diaphragms, has a telecentric structure.

Moreover, the second group lens system 5132 is set to have a great tilt decentration and a parallel decentration with respect to the first group lens system 5131. Here, the tilt decentration refers to a state in which the angle made by the main axis of the lens group with respect to the short conjugate length focus surface FS is any angle except for 0°, and the parallel decentration refers to a state in which the principal ray is set to pass through a position other than the main axis of the lens group. More specifically, with respect to the tilt decentration, a decentering angle of not less than 10° is provided. Here, the decentering angle around the X-axis of the second group lens system 5132 with respect to the first group lens system 5131 is preferably set in the range of −20 to 30°.

Furthermore, the third group lens system 5133 is set to have a great tilt decentration and a parallel decentration with respect to the second group lens system 5132. More specifically, with respect to the tilt decentration, a decentering angle of not less than 10° is provided. Here, the decentering angle around the X-axis of the third group lens system 5133 with respect to the second group lens system 5132 is preferably set in the range of 30 to 40°.

Here, the screen 38 is placed on the rear side of the third group lens system 5133, and the angle between the normal of the screen 38 and the principal ray in the center of an image is set in the range of 35° to 40°, and even with such an angle, the oblique projection optical system allows the entire surface of the screen to be in focus and reduces the distortion aberration to approximately ±10%. In other words, in order to provide such properties, the first group lens system 5131, the second group lens system 5132 and the third group lens system 5133 are off-centered from each other as described above.

Here, in conventional devices, the angle between the normal to the screen 38 and the principal ray of the center of an image is less than 35°, and no conventional devices set the angle to not less than 35°. In the respective examples which will be described below, this angle is set in the range of 38° to 40°.

Moreover, the angle between the normal of the display surface of the DMD 33 or the short conjugate length focal surface FS that is a conjugate face in which its surface is relayed by coaxial systems and the principal ray of the center of an image is set to ±1° , which forms a telecentric system.

Moreover, the tilt decentration of the first group lens system 5131 with respect to the short conjugate length focal surface (FS) (equivalent to the display surface) is set within 1° and the parallel decentration in the Y-axis direction is set within 2 mm.

In order to apply oblique projection to the screen 38, it is necessary to solve problems of out-of-focus and distortion. Although these problems can be solved by making the optical systems partially decentered, it is difficult to process each single lens so as to provide it with decentration.

Therefore, in the present oblique projection optical system, the lens system is divided into three groups of the first group lens system 5131 to the third group lens system 5133, as described above, and in each lens system, neither single lens nor group lenses are decentered. Instead, the relative positions of the three lens systems are decentered from each other.

With this arrangement, since each single lens has no decentration in each lens system, the processing of each single lens is carried out comparatively with ease, and it is also possible to provide an optical system in which the problems of out-of-focus and distortion have been solved. Moreover, the lens system closest to the display surface is provided as a telecentric optical system so that a diaphragm or a beam regulating plate having the same effect as the diaphragm is installed in the group. Further, as described above, the decentration angle of the first group lens system 5131 with respect to the short conjugate length focal surface FS (display surface) is set within 1° and the amount of offset in the Y-axis direction is set within 2 mm; thus, it is possible to minimize the effective diameter of each lens on the display side.

As described above, in accordance with the present preferred embodiment, the oblique projection optical system 513, which corrects distortion aberration and/or focal position on the screen surface, is installed so that it is possible to provide a three-dimensional image display apparatus 100 capable of displaying a three-dimensional image with high precision. Moreover, a position from which a basic image is projected to the screen surface, that is, the position of the projection mirror 37, is set at a position that is allowed to rotate following the screen 38, and is apart from the screen surface with a predetermined distance, with at least an angle except for vertical with respect to the screen surface; therefore, there are no parts shielding the front side of the screen 38 so that it becomes possible to provide better visibility to the screen 38.

Moreover, the oblique projection optical system is provided with a plurality of lenses, and among the lenses, the first group lens system 5131, the second group lens system 5132 and the third group lens system 5133 are relatively decentered from each other; therefore, in comparison with a case in which decentering lenses are used, the systems can be easily manufactured at low costs.

Moreover, the angle between the normal to the screen surface and the principal ray of the center of an image is set to greater than 35° so that it is possible to properly project an image onto the screen 38 that is tilted greatly.

Moreover, in the first group lens system 5131, the tilt decentration with respect to the short conjugate length focal surface FS (that is, display surface of the DMD 33) is set within 1° and the parallel decentration is set within 2 mm; thus, it is possible to minimize the effective diameter of each lens on the display side.

Furthermore, since the first group lens system 5131 includes the beam regulator so that it is possible to easily form a telecentric optical system on the display surface side.

The following description will discuss examples of the oblique projection optical system having the above-mentioned arrangement. Here, not particularly shown in the following examples, in any of the examples, the angle between the normal to the short conjugate length focal surface FS (that is, the display surface of the DMD 33) and the principal ray of the center of an image is precisely set to 0°.

### FIRST EXAMPLE

FIG. 9 is a drawing that shows a light path in oblique projection optical system 513A in accordance with a first example. As illustrated in FIG. 9, the oblique projection optical system 513A is provided with a first group lens system 5131, a second group lens system 5132 and a third group lens system 5133; and the first group lens system 5131 is provided with lenses L1 to L9 and a beam regulator S, the second group lens system 5132 is provided with lenses L10 to L12, and the third group lens system 5133 is provided with lenses L13 to L17, respectively.

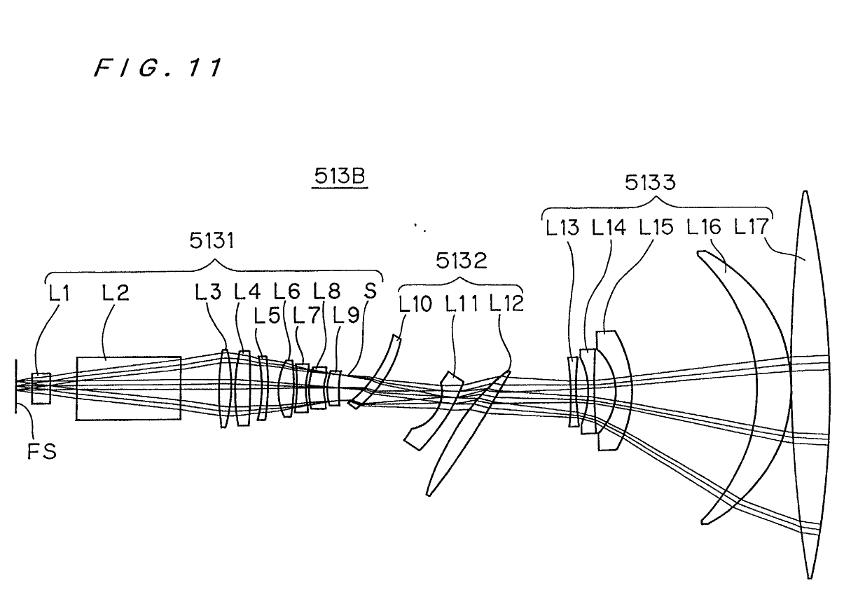

Moreover, FIG. 10 is a drawing that shows a point spread on the screen surface in the case of the oblique projection optical system 513A of the first example. In FIG. 10, supposing that a X-Y coordinates system is defined on the screen surface, the point spread is shown at the respective points in the ranges of −1 ≦−≦1 and −1≦Y≦1, more specifically, at the points of (1.00, −1.00), (1.00, 0.00), (1.00, 1.00), (0.50, −1.00), (0.50, 0.00), (0.50, 1.00), (0.00, −1.00), (0.00, 1.00) and (0.00, 0.00). Here, the numeric value indicated below each of the coordinate values is a coordinate value represented in unit of mm with respect to the origin placed in the center on the display surface. Additionally, even the same X-Y coordinate value has a slight difference when given as a coordinate value on the display surface due to distortion. As illustrated in FIG. 10, in the first example, even though it is oblique projection optical system, a superior point spread is obtained on the entire screen surface.

Tables 1 and 2 show data values in the first example. In Tables 1 and 2, figures on the left side show the respective lens faces from the object side in succession. Moreover, it is supposed that the rotation symmetric axis of each lens is the Z-axis, the longitudinal direction within the face vertical to the Z-axis is defined as the Y-axis and the lateral direction is defined as the X-axis. Here, all numeric values related to lengths are given in unit of mm.

TABLE 1
Distance from the short conjugate length focal surface (display surface)
to the first face apex:
Z = 5.949768 Y = 0.845814 X = 0.0
Decentering angle around the X-axis of the first face with respect to the
short conjugate length focal surface (display surface) = −0.096296°

| | Radius of | Face distance | Refractive | |
|---|---|---|---|---|
| | curvature | on axix | index | Dispersion |
| 1: | ∞ | 6.528000 | 1.516800 | 64.1200 |
| 2: | ∞ | 9.680300 | | |
| 3: | ∞ | 38.221200 | 1.516800 | 64.1200 |
| 4: | ∞ | 14.084700 | | |
| 5: | 75.33759 | 5.841056 | 1.704960 | 52.7453 |
| 6: | −53.92407 | 2.299234 | | |
| 7: | 49.54646 | 7.243995 | 1.539525 | 65.4266 |
| 8: | −573.56333 | 4.517894 | | |
| 9: | −46.48155 | 4.758539 | 1.803185 | 30.5527 |
| 10: | −108.81608 | 3.728823 | | |
| 11: | 22.05642 | 5.997375 | 1.490024 | 70.0624 |
| 12: | −86.86711 | 0.999821 | | |
| 13: | −83.66036 | 3.998264 | 1.784657 | 32.6803 |
| 14: | 39.01111 | 1.823592 | | |
| 15: | 37.21683 | 4.983036 | 1.779282 | 32.1370 |
| 16: | 15.74168 | 1.071080 | | |
| 17: | 16.43048 | 5.000000 | 1.506287 | 68.3665 |
| 18: | 31.30497 | 2.671659 | | |
| Diaphragm: | ∞ | | | |

TABLE 2
Distance from the diaphragm face to the 20^{th} face apex:
Z = 12.661336 Y = 4.735755 X = 0.0
Decentering angle around X-axis of the 20^{th} face with respect
to the diaphragm face = −33.848039°

| | | | | |
|---|---|---|---|---|
| 20: | −47.67927 | 7.018549 | 1.487000 | 70.4000 |
| 21: | −43.10056 | 18.082829 | | |
| 22: | −13.08732 | 6.680422 | 1.504232 | 66.7197 |
| 23: | −63.21998 | 0.100000 | | |
| 24: | 100.91450 | 10.000000 | 1.599302 | 61.4142 |
| 25: | −603.33898 | | | |

Distance from the 25^{th} face apex to the 26^{th} face apex:
Z = 22.189491 Y = 31.252037 X = 0.0
Decentering angle around X-axis of the 26^{th} face with respect
to the 25^{th} face = 38.791046°

| | | | | |
|---|---|---|---|---|
| 26: | −65.65142 | 5.779867 | 1.487000 | 70.4000 |
| 27: | 40.76688 | 8.176854 | | |
| 28: | −15.20945 | 2.500000 | 1.487000 | 70.4000 |
| 29: | −113.18171 | 17.561662 | | |
| 30: | −34.98483 | 10.000000 | 1.797822 | 31.7222 |
| 31: | −31.98704 | 23.353005 | | |
| 32: | −64.25078 | 8.210612 | 1.847000 | 23.8000 |
| 33: | −90.92535 | 18.000000 | 1.750000 | 50.0000 |
| 34: | −58.40176 | | | |

Distance from the 34^{th} face apex to the screen surface:
Z = 1040.715312 Y = −100.0307891
Decentering angle around X-axis of the screen surface with respect
to the 34^{th} face =−44.534065°
Diaphragm diameter = 4.359293 Angle between normal to screen
surface and principal ray in the center of an image = 40°

As shown in Table 1 and Table 2, in the first example, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focus surface FS (display surface), and the angle between the normal to the screen surface and the principal ray in the center of an image is set to 40°. In this manner, the oblique projection optical system 513A in the first example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 10. This indicates that the oblique projection optical system 513A makes it possible to properly correct the focal positions over the entire screen surface.

### SECOND EXAMPLE

FIG. 11 is a drawing that shows a light path in oblique projection optical system 513B in accordance with a second example. As illustrated in FIG. 11, the oblique projection optical system 513B is provided with a first group lens system 5131, a second group lens system 5132 and a third group lens system 5133; and the first group lens system 5131 is provided with lenses L1 to L9 and a beam regulator S, the second group lens system 5132 is provided with lenses L10 to L12, and the third group lens system 5133 is provided with lenses L13 to L17, respectively.

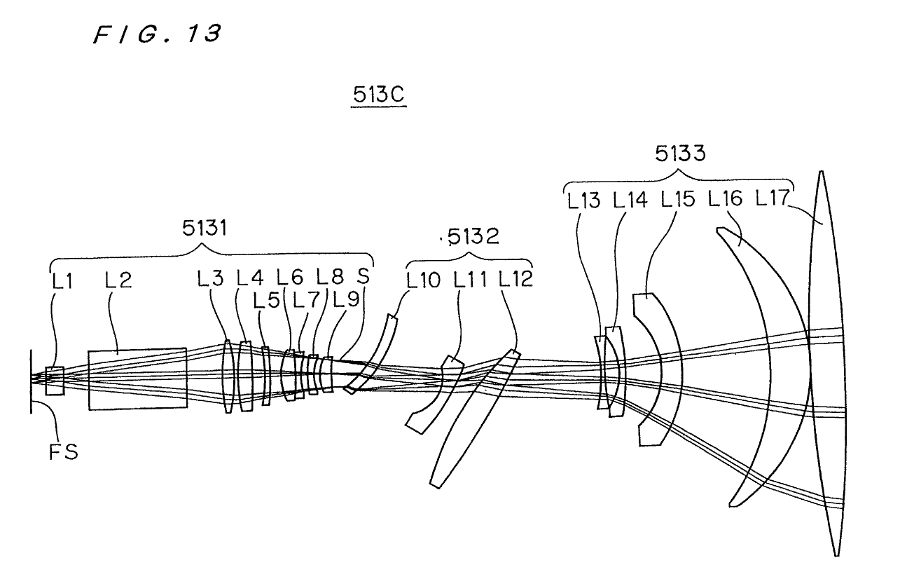

Moreover, FIG. 12 is a drawing that shows a point spread on the screen surface in the case of the oblique projection optical system 513B of the second example. In FIG. 12 also, the X-Y coordinates system on the screen surface is defined and the coordinate system on the display surface is defined in the same manner as FIG. 10, and the point spread is shown at the respective coordinate points. As shown in the Figures, in the second example also, although it is oblique projection optical system, a superior point spread is obtained over the entire screen face.

Tables 3 and 4 show data values in the second example. The respective numeric values in these Tables and the X-axis, Y-axis and Z-axis are defined in the same manner as the first example.

TABLE 3
Distance from the short conjugate length focal surface (display surface)
to the first face apex:
Z = 5.949768 Y = −1.308371 X = 0.0
Decentering angle around the X-axis of the first face with respect to the
short conjugate length focal surface (display surface) = −0.583514°

| | Radius of | Face distance | Refractive | |
|---|---|---|---|---|
| | curvature | on axix | index | Dispersion |
| 1: | ∞ | 6.528000 | 1.516800 | 64.1200 |
| 2: | ∞ | 9.680300 | | |
| 3: | ∞ | 38.221200 | 1.516800 | 64.1200 |
| 4: | ∞ | 14.084700 | | |
| 5: | 73.85458 | 4.830500 | 1.705397 | 49.5496 |
| 6: | −54.04729 | 1.073698 | | |
| 7: | 56.47422 | 5.956284 | 1.539670 | 65.4151 |
| 8: | −286.53392 | 4.440318 | | |
| 9: | −45.53007 | 2.000000 | 1.791655 | 33.2054 |
| 10: | −95.87581 | 3.769121 | | |
| 11: | 22.26876 | 5.822063 | 1.490909 | 69.9650 |
| 12: | −89.96370 | 1.009653 | | |
| 13: | −90.30883 | 3.778571 | 1.780552 | 31.6632 |
| 14: | 37.03083 | 0.945371 | | |
| 15: | 35.71668 | 4.994815 | 1.767475 | 30.5619 |
| 16: | 15.99770 | 1.103573 | | |
| 17: | 17.12999 | 4.482808 | 1.516997 | 67.3489 |
| 18: | 33.93408 | 1.500000 | | |
| Diaphragm: | ∞ | | | |

TABLE 4
Distance from the diaphragm face to the 20^{th} face apex:
Z = 12.733428 Y = 5.608071 X = 0.0
Decentering angle around X-axis of the 20^{th} face with respect
to the diaphragm face = −32.586912°

| | | | | |
|---|---|---|---|---|
| 20: | −39.93170 | 3.652252 | 1.487000 | 70.4000 |
| 21: | −38.95472 | 22.956336 | | |
| 22: | −13.09838 | 4.000000 | 1.487000 | 70.4000 |
| 23: | −75.89404 | 5.648772 | | |
| 24: | 89.53553 | 6.376519 | 1.487000 | 70.4000 |
| 25: | −407.51200 | | | |

Distance from the 25^{th} face apex to the 26^{th} face apex:
Z = 22.263321 Y = 33.694665 X = 0.0
Decentering angle around X-axis of the 26^{th} face with respect
to the 25^{th} face = 34.502529°

| | | | | |
|---|---|---|---|---|
| 26: | −97.92713 | 2.000000 | 1.827195 | 24.3214 |
| 27: | 84.31410 | 4.577575 | | |
| 28: | −27.70310 | 2.500000 | 1.487000 | 70.4000 |
| 29: | 481.59087 | 7.515467 | | |
| 30: | −20.81969 | 6.000000 | 1.487000 | 70.4000 |
| 31: | −41.68266 | 45.331090 | | |
| 32: | −67.88034 | 12.000000 | 1.798199 | 31.6367 |
| 33: | −56.93636 | 0.100000 | | |
| 34: | 481.86477 | 13.557868 | 1.750000 | 50.0000 |
| 35: | −364.60557 | | | |

Distance from the 35^{th} face apex to the screen surface:
Z = 1056.711449 Y = −97.185953 X = 0.0
Decentering angle around X-axis of the screen surface with respect
to the 35^{th} face =−44.165138°
Diaphragm diameter = 4.821992 Angle between normal to screen
surface and principal ray in the center of an image = 40°

As shown in Table 3 and Table 4, in the second example, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 40°. In this manner, the oblique projection optical system 513B in the second example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 12. This indicates that the oblique projection optical system 513B makes it possible to properly correct the focal positions over the entire screen surface.

### THIRD EXAMPLE

FIG. 13 is a drawing that shows a light path in oblique projection optical system 513C in accordance with a third example. As illustrated in FIG. 13, the oblique projection optical system 513C is provided with a first group lens system 5131, a second group lens system 5132 and a third group lens system 5133; and the first group lens system 5131 is provided with lenses L1 to L9 and a beam regulator S, the second group lens system 5132 is provided with lenses L10 to L12, and the third group lens system 5133 is provided with lenses L13 to L17, respectively.

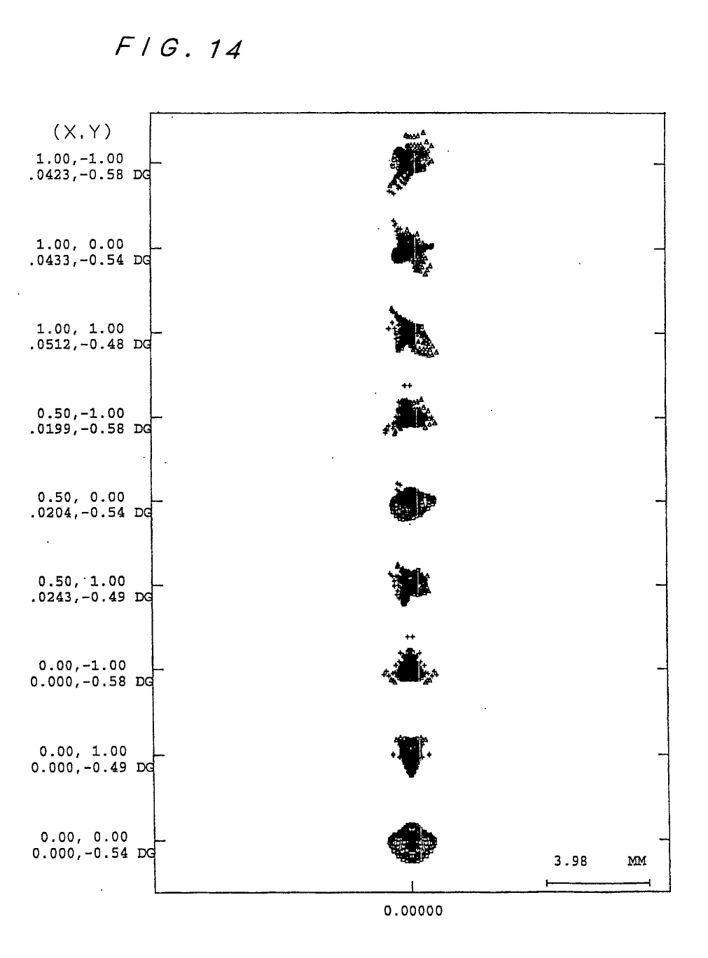

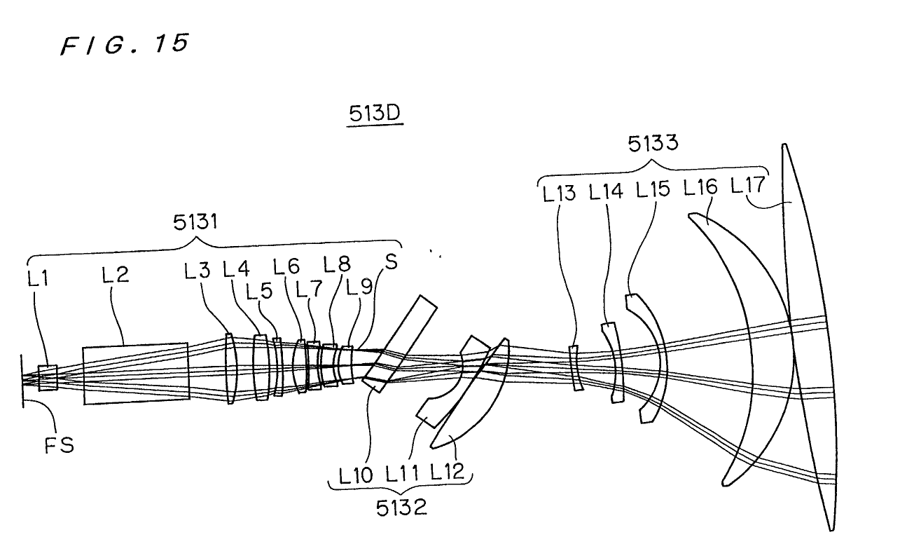

Moreover, FIG. 14 is a drawing that shows a point spread on the screen surface in the case of the oblique projection optical system 513C of the third example. In FIG. 14 also, the X-Y coordinates system on the screen surface is defined and the coordinate system on the display surface is defined in the same manner as FIG. 10, and the point spread is shown at the respective coordinate points. As shown in the Figures, in the third example also, although it is oblique projection optical system, a superior point spread is obtained over the entire screen face.

Tables 5 and 6 show data values in the third example. The respective numeric values in these Tables and the X-axis, Y-axis and Z-axis are defined in the same manner as the first example.

TABLE 5
Distance from the short conjugate length focal surface (display surface)
to the first face apex:
Z = 5.949768 Y = −1.122473 X = 0.0
Decentering angle around the X-axis of the first face with respect to the
short conjugate length focal surface (display surface) = −0.567467°

| | Radius of | Face distance | Refractive | |
|---|---|---|---|---|
| | curvature | on axix | index | Dispersion |
| 1: | ∞ | 6.528000 | 1.516800 | 64.1200 |
| 2: | ∞ | 9.680300 | | |
| 3: | ∞ | 38.221200 | 1.516800 | 64.1200 |
| 4: | ∞ | 14.084700 | | |
| 5: | 74.28003 | 4.733831 | 1.707388 | 51.3674 |
| 6: | −53.86271 | 1.203080 | | |
| 7: | 56.93716 | 5.938692 | 1.543403 | 65.1222 |
| 8: | −318.59371 | 4.983707 | | |
| 9: | −46.52361 | 2.000000 | 1.778859 | 35.1952 |
| 10: | −92.19303 | 4.079296 | | |
| 11: | 22.50276 | 5.874315 | 1.493659 | 69.6662 |
| 12: | −96.92982 | 0.029414 | | |
| 13: | −96.92982 | 2.538293 | 1.773389 | 32.8665 |
| 14: | 44.84663 | 2.012741 | | |
| 15: | 40.15791 | 2.542965 | 1.754062 | 32.1014 |
| 16: | 16.02325 | 2.075011 | | |
| 17: | 16.39374 | 4.545680 | 1.530933 | 66.1275 |
| 18: | 29.87854 | 2.000000 | | |
| Diaphragm: | ∞ | | | |

TABLE 6
Distance from the diaphragm face to the 20^{th} face apex:
Z = 14.58785 Y = 6.781019 X = 0.0
Decentering angle around X-axis of the 20^{th} face with respect
to the diaphragm face = −32.351118°

| | | | | |
|---|---|---|---|---|
| 20: | −47.26686 | 4.070155 | 1.487000 | 70.4000 |
| 21: | −46.04827 | 25.767757 | | |
| 22: | −13.90173 | 4.000000 | 1.487000 | 70.4000 |
| 23: | −77.45419 | 6.844086 | | |
| 24: | 108.99735 | 10.000000 | 1.487000 | 70.4000 |
| 25: | −270.24506 | | | |

Distance from the 25^{th} face apex to the 26^{th} face apex:
Z = 29.323286 Y = 41.451338 X = 0.0
Decentering angle around X-axis of the 26^{th} face with respect
to the 25^{th} face = 34.092103°

| | | | | |
|---|---|---|---|---|
| 26: | −57.86728 | 1.700000 | 1.184700 | 23.8000 |
| 27: | 82.82463 | 5.589318 | | |
| 28: | −23.16223 | 2.500000 | 1.487000 | 70.4000 |
| 29: | −86.04849 | 13.764594 | | |
| 30: | −28.01500 | 8.000000 | 1.487000 | 70.4000 |
| 31: | −47.75515 | 33.928089 | | |
| 32: | −85.78069 | 15.000000 | 1.792574 | 32.9741 |
| 33: | −63.09082 | 0.100000 | | |
| 34: | 432.62289 | 13.000000 | 1.750000 | 50.0000 |
| 35: | −533.52771 | 0.000000 | | |
| 36: | ∞ | | | |

Distance from the 35^{th} face apex to the screen surface:
Z = 1082.747374 Y = −89.8748672 X = 0.0
Decentering angle around X-axis of the screen surface with respect
to the 35^{th} face =−43.722341°
Diaphragm diameter = 5.273248 Angle between normal to screen
surface and principal ray in the center of an image = 40°

As shown in Table 5 and Table 6, in the third example also, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 40°. In this manner, the oblique projection optical system 513C in the third example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 14. This indicates that the oblique projection optical system 513C makes it possible to properly correct the focal positions over the entire screen surface.

### FOURTH EXAMPLE

FIG. 15 is a drawing that shows a light path in oblique projection optical system 513D in accordance with a fourth example. As illustrated in FIG. 15, the oblique projection optical system 513D is provided with a first group lens system 5131, a second group lens system 5132 and a third group lens system 5133; and the first group lens system 5131 is provided with lenses L1 to L9 and a beam regulator S, the second group lens system 5132 is provided with lenses L10 to L12, and the third group lens system 5133 is provided with lenses L13 to L17, respectively.

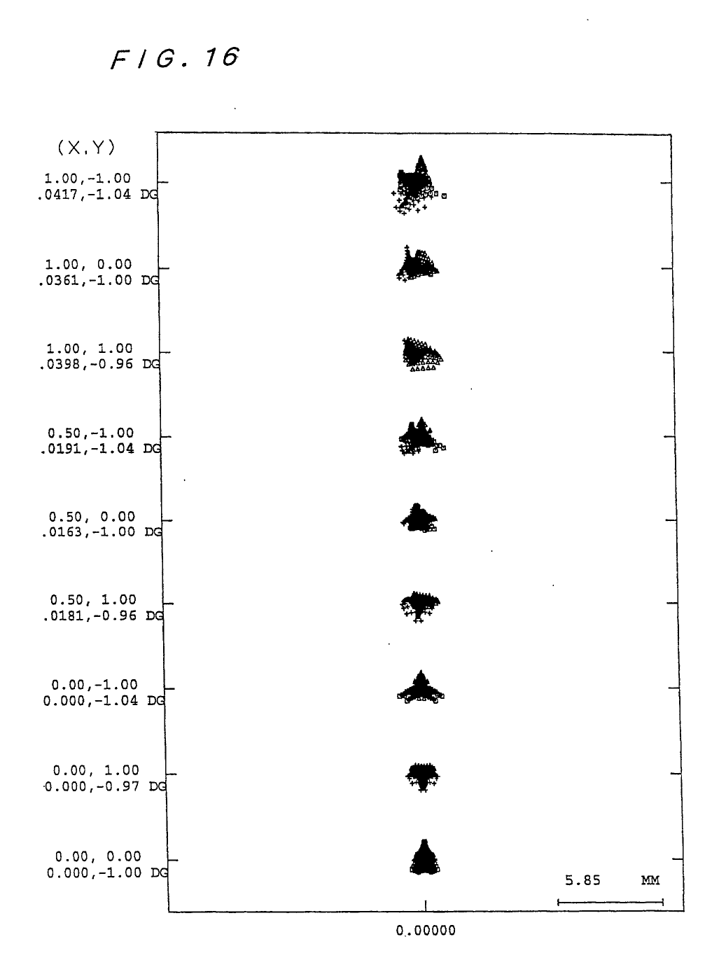

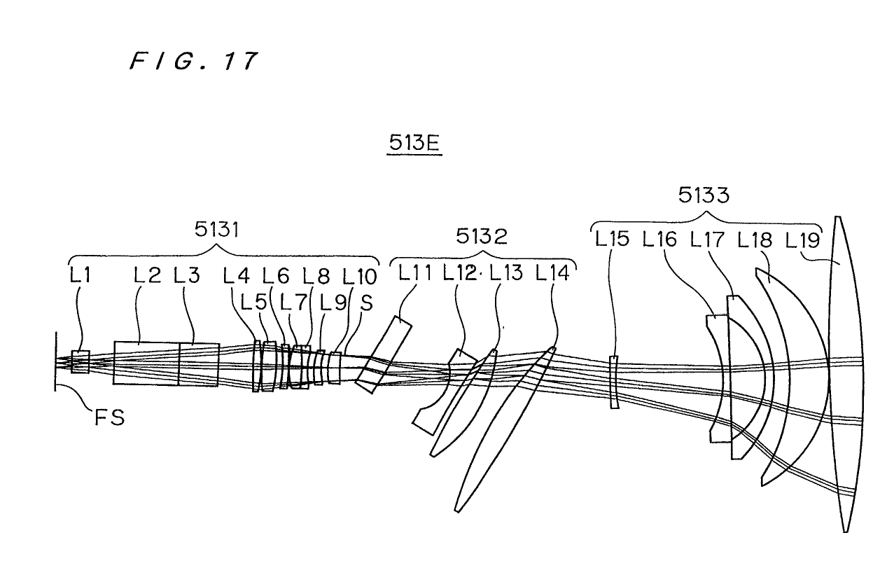

Moreover, FIG. 16 is a drawing that shows a point spread on the screen surface in the case of the oblique projection optical system 513D of the fourth example. In FIG. 16 also, the X-Y coordinates system on the screen surface is defined and the coordinate system on the display surface is defined in the same manner as FIG. 10, and the point spread is shown at the respective coordinate points. As shown in FIG. 16, in the fourth example also, although it is oblique projection optical system, a superior point spread is obtained over the entire screen face.

Tables 7 and 8 show data values in the fourth example. The respective numeric values in these Tables and the X-axis, Y-axis and Z-axis are defined in the same manner as the first example.

TABLE 7
Distance from the short conjugate length focal surface (display surface)
to the first face apex:
Z = 5.949768 Y = 0.067101 X = 0.0
Decentering angle around the X-axis of the first face with respect to the
short conjugate length focal surface (display surface) = −0.996571°

| | Radius of | Face distance | Refractive | |
|---|---|---|---|---|
| | curvature | on axix | index | Dispersion |
| 1: | ∞ | 6.528000 | 1.516800 | 64.1200 |
| 2: | ∞ | 9.680300 | | |
| 3: | ∞ | 38.221200 | 1.516800 | 64.1200 |
| 4: | ∞ | 14.084700 | | |
| 5: | 113.94575 | 4.333024 | 1.703335 | 52.8569 |
| 6: | −43.15745 | 6.012567 | | |
| 7: | 81.82446 | 6.000000 | 1.536051 | 65.7055 |
| 8: | −69.75852 | 3.108973 | | |
| 9: | −34.86769 | 2.000000 | 1.775946 | 33.6764 |
| 10: | −84.20953 | 3.690402 | | |
| 11: | 23.46113 | 5.272109 | 1.490450 | 70.0154 |
| 12: | −87.07677 | 0.473583 | | |
| 13: | −106.13471 | 3.589513 | 1.767016 | 35.6746 |
| 14: | 37.45404 | 1.063644 | | |
| 15: | 39.34728 | 4.889980 | 1.742340 | 40.5256 |
| 16: | 17.40803 | 1.633282 | | |
| 17: | 15.70858 | 4.853463 | 1.543687 | 65.1001 |
| 18: | 30.07761 | 1.500000 | | |
| Diaphragm: | ∞ | | | |

TABLE 8
Distance from the diaphragm face to the 20^{th} face apex:
Z = 13.628212 Y = 8.834915 X = 0.0
Decentering angle around X-axis of the 20^{th} face with respect
to the diaphragm face = −36.654220°

| | | | | |
|---|---|---|---|---|
| 20: | −1000.00000 | 8.000000 | 1.651849 | 32.5172 |
| 21: | −1000.00000 | 22.205981 | | |
| 22: | −11.91452 | 4.000000 | 1.517232 | 67.3273 |
| 23: | −93.76220 | 0.100000 | | |
| 24: | 485.28331 | 11.000000 | 1.628354 | 59.3620 |
| 25: | −38.14977 | | | |

Distance from the 25^{th} face apex to the 26^{th} face apex:
Z = 16.967477 Y = 29.343573 X = 0.0
Decentering angle around X-axis of the 26^{th} face with respect
to the 25^{th} face = 42.461399°

| | | | | |
|---|---|---|---|---|
| 26: | 893.04084 | 2.000000 | 1.847000 | 23.8000 |
| 27: | 30.62958 | 13.704967 | | |
| 28: | −30.93346 | 2.500000 | 1.847000 | 23.8000 |
| 29: | −107.16827 | 14.220811 | | |
| 30: | −23.09491 | 2.500000 | 1.750000 | 50.0000 |
| 31: | −37.42524 | 30.556222 | | |
| 32: | −82.24677 | 15.000000 | 1.844639 | 24.0726 |
| 33: | −58.67561 | 0.100000 | | |
| 34: | 536.01143 | 13.000000 | 1.727982 | 51.2631 |
| 35: | −375.20273 | | | |

Distance from the 35^{th} face apex to the screen surface:
Z = 1024.755636 Y = −146.8563819 X = 0.0
Decentering angle around X-axis of the screen surface with respect
to the 35^{th} face =−46.300866°
Diaphragm diameter = 5.319092 Angle between normal to screen
surface and principal ray in the center of an image = 40°

As shown in Table 7 and Table 8, in the fourth example also, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 40°. In this manner, the oblique projection optical system 513D in the fourth example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 16. This indicates that the oblique projection optical system 513D makes it possible to properly correct the focal positions over the entire screen surface.

### FIFTH EXAMPLE

FIG. 17 is a drawing that shows a light path in oblique projection optical system 513E in accordance with a fifth example. As illustrated in FIG. 17, the oblique projection optical system 513E is provided with a first group lens system 5131, a second group lens system 5132 and a third group lens system 5133; and the first group lens system 5131 is provided with lenses L1 to L10 and a beam regulator S, the second group lens system 5132 is provided with lenses L11 to L14, and the third group lens system 5133 is provided with lenses L15 to L19, respectively.

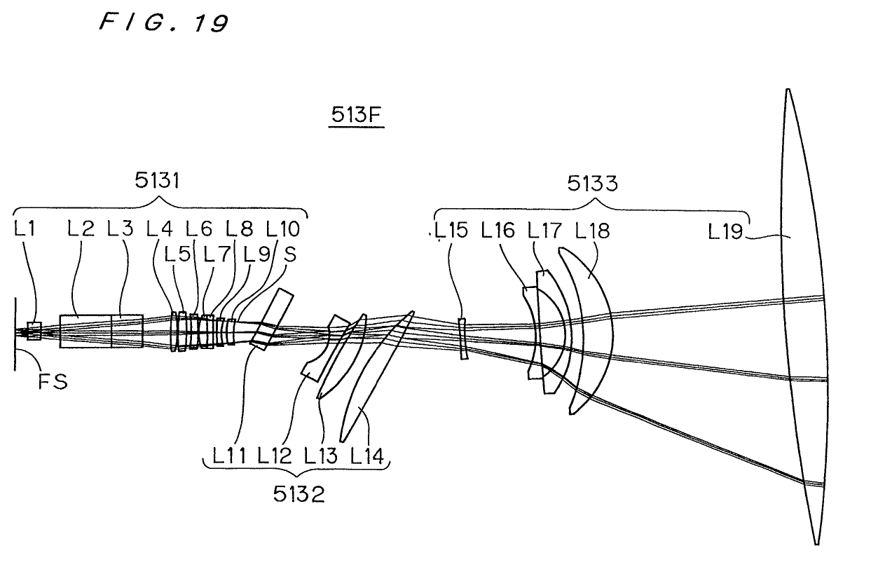

Moreover, FIG. 18 is a drawing that shows a point spread on the screen surface in the case of the oblique projection optical system 513E of the fifth example. In FIG. 18 also, the X-Y coordinates system on the screen surface is defined and the coordinate system on the display surface is defined in the same manner as FIG. 10, and the point spread is shown at the respective coordinate points. As shown in FIG. 18, in the fifth example also, although it is oblique projection optical system, a superior point spread is obtained over the entire screen face.

Tables 9 and 10 show data values in the fifth example. The respective numeric values in these Tables and the X-axis, Y-axis and Z-axis are defined in the same manner as the first example.

TABLE 9
Distance from the short conjugate length focal surface (display surface)
to the first face apex:
Z = 6.000000 Y = 0.529822 X = 0.0
Decentering angle around the X-axis of the first face with respect to the
short conjugate length focal surface (display surface) = −0.35390°

| | Radius of | Face distance | Refractive | |
|---|---|---|---|---|
| | curvature | on axix | index | Dispersion |
| 1: | ∞ | 6.528000 | 1.516800 | 64.1200 |
| 2: | ∞ | 9.680300 | | |
| 3: | ∞ | 25.541600 | 1.516800 | 64.1200 |
| 4: | ∞ | 15.373600 | 1.846660 | 23.8200 |
| 5: | ∞ | 14.084700 | | |
| 6: | 113.44442 | 3.374433 | 1.708209 | 52.5250 |
| 7: | −42.34061 | 0.100000 | | |
| 8: | 79.21774 | 5.907913 | 1.541902 | 65.2392 |
| 9: | −56.49506 | 2.592473 | | |
| 10: | −39.72059 | 2.169390 | 1.762688 | 35.0879 |
| 11: | −292.89048 | 0.100000 | | |
| 12: | 23.65028 | 5.051883 | 1.496005 | 69.4159 |
| 13: | −82.53851 | 2.499901 | 1.754040 | 37.4847 |
| 14: | 50.69722 | 2.533144 | | |
| 15: | 50.96294 | 2.490963 | 1.720437 | 44.4215 |
| 16: | 19.29961 | 2.544468 | | |
| 17: | 18.85957 | 4.990256 | 1.568492 | 42.4005 |
| 18: | 42.34971 | 1.500000 | | |
| Diaphragm: | ∞ | | | |

TABLE 10
Distance from the diaphragm face to the 20^{th} face apex:
Z = 12.327426 Y = 7.839569 X = 0.0
Decentering angle around X-axis of the 20^{th} face with respect
to the diaphragm face = −29.213854°

| | | | | |
|---|---|---|---|---|
| 20: | ∞ | 8.000000 | 1.847000 | 23.8000 |
| 21: | ∞ | 25.247334 | | |
| 22: | −14.07095 | 4.000000 | 1.487000 | 70.4000 |
| 23: | 261.55184 | 2.229494 | | |
| 24: | 205.64301 | 9.000000 | 1.487000 | 70.4000 |
| 25: | −51.55262 | 6.770506 | | |
| 26: | 125.44677 | 9.000000 | 1.487000 | 70.4000 |
| 27: | −449.47255 | 24.421910 | | |

Distance from the 27^{th} face apex to the 28^{th} face apex:
Z = 24.421910 Y = 37.630668 X = 0.0
Decentering angle around X-axis of the 27^{th} face with respect
to the 25^{th} face = 33.262617°

| | | | | |
|---|---|---|---|---|
| 28: | −705.15080 | 2.000000 | 1.847000 | 23.8000 |
| 29: | 47.33251 | 42.266891 | | |
| 30: | −41.63109 | 2.500000 | 1.750000 | 50.0000 |
| 31: | −1549.46272 | 14.208903 | | |
| 32: | −27.97234 | 3.300000 | 1.738271 | 50.6556 |
| 33: | −45.64841 | 6.083346 | | |
| 34: | −71.57645 | 15.000000 | 1.820990 | 27.3047 |
| 35: | −48.40633 | 0.100000 | | |
| 36: | 496.73527 | 13.000000 | 1.750000 | 50.0000 |
| 37: | −273.21549 | | | |

Distance from the 37^{th} face apex to the screen surface:
Z = 968.6672109 Y = −140.3129543 X = 0.0
Decentering angle around X-axis of the screen surface with respect
to the 37^{th} face =−47.041713°
Flat plate for protecting screen:
Thickness = 6.00 Refractive index = 1.49140 Dispersion = 57.82
Diaphragm diameter = 3.880331 Angle between normal to screen
surface and principal ray in the center of an image = 40°

As shown in Table 9 and Table 10, in the fifth example also, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 40°. In this manner, the oblique projection optical system 513E in the fifth example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 18. This indicates that the oblique projection optical system 513E makes it possible to properly correct the focal positions over the entire screen surface.

### SIXTH EXAMPLE

FIG. 19 is a drawing that shows a light path in oblique projection optical system 513F in accordance with a sixth example. As illustrated in FIG. 19, the oblique projection optical system 513F is provided with a first group lens system 5131, a second group lens system 5132 and a third group lens system 5133; and the first group lens system 5131 is provided with lenses L1 to L10 and a beam regulator S, the second group lens system 5132 is provided with lenses L11 to L14, and the third group lens system 5133 is provided with lenses L15 to L19, respectively.

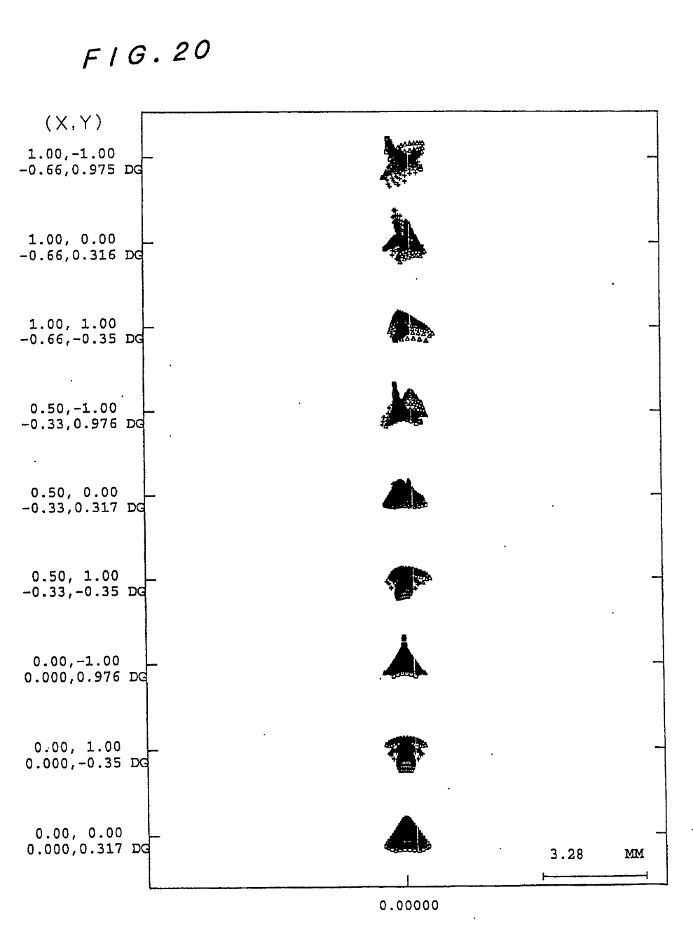

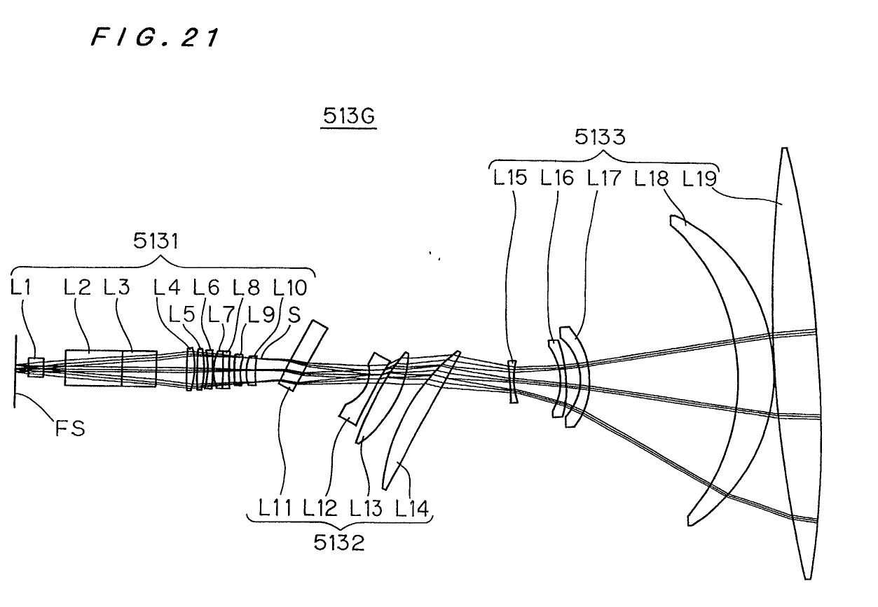

Moreover, FIG. 20 is a drawing that shows a point spread on the screen surface in the case of the oblique projection optical system 513F of the sixth example. In FIG. 20 also, the X-Y coordinates system on the screen surface is defined and the coordinate system on the display surface is defined, in the same manner as FIG. 10, and the point spread is shown at the respective coordinate points. As shown in FIG. 20, in the sixth example also, although it is oblique projection optical system, a superior point spread is obtained over the entire screen face.

Tables 11 and 12 show data values in the sixth example. The respective numeric values in these Tables and the X-axis, Y-axis and Z-axis are defined in the same manner as the first example.

TABLE 11
Distance from the short conjugate length focal surface (display surface) to
the first face apex:
Z = 6.000000 Y = 0.729656 X = 0.0
Decentering angle around the X-axis of the first face with respect to
the short conjugate length focal surface (display surface) = 0.021305°

| | | | |
|---|---|---|---|
| Radius of | Face distance | Refractive | |
| curvature | on axis | index | Dispersion |

| | | | | |
|---|---|---|---|---|
| 1: | ∞ | 6.528000 | 1.516800 | 64.1200 |
| 2: | ∞ | 9.680300 | | |
| 3: | ∞ | 25.541600 | 1.516800 | 64.1200 |
| 4: | ∞ | 15.373600 | 1.846660 | 23.8200 |
| 5: | ∞ | 14.084700 | | |
| 6: | 98.03684 | 3.368332 | 1.713000 | 53.9300 |
| 7: | −43.12470 | 0.140716 | | |
| 8: | 101.01689 | 4.489869 | 1.563840 | 60.8300 |
| 9: | −53.68387 | 2.369961 | | |
| 10: | −38.43325 | 2.989132 | 1.806100 | 32.2700 |
| 11: | −161.15564 | 0.636991 | | |
| 12: | 24.17058 | 4.495610 | 1.487490 | 70.4400 |
| 13: | −94.42883 | 2.452344 | 1.775510 | 37.9000 |
| 14: | 56.30284 | 2.011187 | | |
| 15: | 52.40108 | 2.451651 | 1.744000 | 44.9300 |
| 16: | 19.61209 | 2.319062 | | |
| 17: | 19.12781 | 3.931340 | 1.581440 | 40.8900 |
| 18: | 41.63622 | 1.602280 | | |
| Diaphragm: | ∞ | | | |

TABLE 12
Distance from the diaphragm face to the 20^{th} face apex:
Z = 13.974411 Y = 8.17488 X = 0.0
Decentering angle around X-axis of the 20^{th} face with
respect to the diaphragm face = −27.809781°

| | | | | |
|---|---|---|---|---|
| 20: | ∞ | 8.000000 | 1.846660 | 23.8200 |
| 21: | ∞ | 27.032571 | | |
| 22: | −14.69214 | 4.000000 | 1.487490 | 70.4400 |
| 23: | 175.70622 | 2.269175 | | |
| 24: | 161.59147 | 9.000000 | 1.487490 | 70.4400 |
| 25: | −53.89157 | 6.730825 | | |
| 26: | 106.50594 | 9.000000 | 1.487490 | 70.4400 |
| 27: | −999.99490 | | | |

Distance from the 27^{th} face apex to the 28^{th} face apex:
Z = 26.524091 Y = 36.734257 X = 0.0
Decentering angle around X-axis of the 28^{th} face with respect to the
27^{th} face = 32.670877°

| | | | | |
|---|---|---|---|---|
| 28: | −171.79506 | 2.000000 | 1.846660 | 23.8200 |
| 29: | 50.39937 | 37.232271 | | |
| 30: | −43.14722 | 2.500000 | 1.772500 | 49.7700 |
| 31: | −7294.92020 | 12.891325 | | |
| 32: | −26.48702 | 3.300000 | 1.620410 | 60.3400 |
| 33: | −51.14594 | 5.683093 | | |
| 34: | −86.94265 | 15.000000 | 1.805180 | 25.4300 |
| 35: | −49.70172 | 85.393311 | | |
| 36: | 839.19597 | 20.000000 | 1.775510 | 37.9000 |
| 37: | −623.71943 | | | |

Distance from the 37^{th} face apex to the screen surface:
Z = 728.7220047 Y = −59.9869675 X = 0.0
Decentering angle around X-axis of the screen surface with
respect to the 37^{th} face = 46.750441°
Flat plate for protecting screen: Thickness = 6.00
Refractive index = 1.49140 Dispersion = 57.82
Diaphragm diameter = 5.113682 Angle between normal to screen surface
and principal ray in the center of an image = 40°

As shown in Table 11 and Table 12, in the sixth example also, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 40°. In this manner, the oblique projection optical system 513F in the sixth example satisfies the aforementioned conditions in the present preferred embodiment.

Moreover, although the angle between the normal to the screen surface and the principal ray in the center of an image has a tilt angle of 40°, a superior point spread is obtained on the entire screen surface as shown in FIG. 20. This indicates that the oblique projection optical system 513F makes it possible to properly correct the focal positions over the entire screen surface.

### SEVENTH EXAMPLE

FIG. 21 is a drawing that shows a light path in oblique projection optical system 513G in accordance with a seventh example. As illustrated in FIG. 21, the oblique projection optical system 513G is provided with a first group lens system 5131, a second group lens system 5132 and a third group lens system 5133; and the first group lens system 5131 is provided with lenses L1 to L10 and a beam regulator S, the second group lens system 5132 is provided with lenses L11 to L14, and the third group lens system 5133 is provided with lenses L15 to L19, respectively.

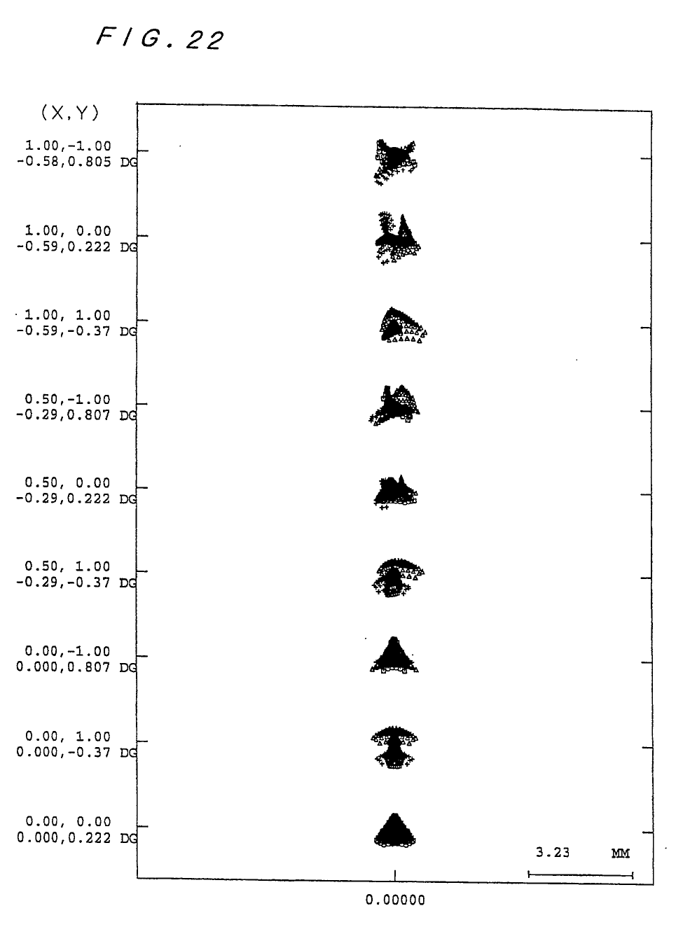

Moreover, FIG. 22 is a drawing that shows a point spread on the screen surface in the case of the oblique projection optical system 513G of the seventh example. In FIG. 22 also, the X-Y coordinates system on the screen surface is defined and the coordinate system on the display surface is defined, in the same manner as FIG. 10, and the point spread is shown at the respective coordinate points. As shown in FIG. 22, in the seventh example also, although it is oblique projection optical system, a superior point spread is obtained over the entire screen face.

Tables 13 and 14 show data values in the seventh example. The respective numeric values in these Tables and the X-axis, Y-axis and Z-axis are defined in the same manner as the first example.

TABLE 13
Distance from the short conjugate length focal surface (display
surface) to the first face apex:
Z = 6.097202 Y = 0.616367 X = 0.0
Decentering angle around the X-axis of the first face with respect to
the short conjugate length focal surface (display surface) = 0.0°

| | Radius of | Face distance | Refractive | |
|---|---|---|---|---|
| | curvature | on axis | index | Dispersion |
| 1: | ∞ | 6.528000 | 1.516800 | 64.1200 |
| 2: | ∞ | 9.680300 | | |
| 3: | ∞ | 25.541600 | 1.516800 | 64.1200 |
| 4: | ∞ | 15.373600 | 1.846660 | 23.8200 |
| 5: | ∞ | 14.084700 | | |
| 6: | 140.87200 | 3.400000 | 1.713000 | 53.9300 |
| 7: | −37.16100 | 1.180000 | | |
| 8: | 224.03000 | 3.200000 | 1.563840 | 60.8300 |
| 9: | −40.78400 | 1.470000 | | |
| 10: | −32.42700 | 2.400000 | 1.806100 | 33.2700 |
| 11: | −96.11900 | 0.390000 | | |
| 12: | 24.71100 | 4.400000 | 1.487490 | 70.4400 |
| 13: | −84.34100 | 2.500000 | 1.775510 | 37.9000 |
| 14: | 54.74900 | 2.440000 | | |
| 15: | 52.28800 | 2.500000 | 1.754500 | 51.5700 |
| 16: | 20.45000 | 3.280000 | | |
| 17: | 19.55200 | 4.300000 | 1.581440 | 40.8700 |
| 18: | 44.09800 | 3.770000 | | |
| Diaphragm: | ∞ | | | |

TABLE 14
Distance from the diaphragm face to the 20^{th} face apex:
Z = 14.330000 Y = 8.841067 X = 0.0
Decentering angle around X-axis of the 20^{th} face with respect to the
diaphragm face = 27.00°

| | | | | |
|---|---|---|---|---|
| 20: | ∞ | 8.000000 | 1.688930 | 31.1600 |
| 21: | ∞ | 28.880000 | | |
| 22: | −15.30000 | 4.000000 | 1.487490 | 70.4400 |
| 23: | 136.41200 | 2.300000 | | |
| 24: | 126.42900 | 9.000000 | 1.487490 | 70.4400 |
| 25: | −55.76000 | 6.650000 | | |
| 26: | 88.90300 | 9.000000 | 1.487490 | 70.4400 |
| 27: | 3050.00000 | | | |

Distance from the 27^{th} face apex to the 28^{th} face apex:
Z = 27.600000 Y = 34.746295 X = 0.0
Decentering angle around X-axis of the 28^{th} face with respect to the
27^{th} face = 32.126851°

| | | | | |
|---|---|---|---|---|
| 28: | −148.15900 | 2.000000 | 1.846660 | 23.8200 |
| 29: | 35.32500 | 22.090000 | | |
| 30: | −28.75200 | 2.630000 | 1.772500 | 49.7700 |
| 31: | −57.90100 | 7.070000 | | |
| 32: | −24.51200 | 3.900000 | 1.772500 | 49.7700 |
| 33: | −37.46100 | 67.400000 | | |
| 34: | −98.98400 | 16.500000 | 1.846660 | 23.8200 |
| 35: | −82.50000 | 0.100000 | | |
| 36: | 576.64500 | 19.700000 | 1.584000 | 31.0000 |
| 37: | −576.64500 | | | |

Distance from the 37^{th} face apex to the screen surface:
Z = 670.117137 Y = −34.895616 X = 0.0
Decentering angle around X-axis of the screen surface with respect
to the 37^{th} face = −42.906623°
Flat plate for protecting screen: Thickness = 6.00
Refractive index = 1.49140 Dispersion = 57.82
Diaphragm diameter = 5.2511605 Angle between normal to screen
surface and principal ray in the center of an image = 38.5°

As shown in Table 13 and Table 14, in the seventh example also, the second group lens system 5132 has a great tilt decentration to the first group lens system 5131, and the third group lens system 5133 also has a great tilt decentration to the second group lens system 5132. Moreover, the decentering angle of the tilt decentration around the X-axis of the first group lens system 5131 is set within ±1° with respect to the short conjugate length focal surface FS (display surface), and the angle between the normal to the screen surface and the principal ray in the center of an image is set to 38.5°. In this manner, the oblique projection optical system 513G in the seventh example satisfies the aforementioned conditions in the present preferred embodiment.

Moreover, although the angle between the normal to the screen surface and the principal ray in the center of an image has a tilt angle of 38.5°, a superior point spread is obtained on the entire screen surface as shown in FIG. 22. This indicates that the oblique projection optical system 513G makes it possible to properly correct the focal positions over the entire screen surface.

<D. Modified Example>

In the above-mentioned preferred embodiment, examples of the projection apparatus and oblique projection optical system have been given; however, the present invention is not limited by these.

For example, in the above-mentioned preferred embodiment, the oblique projection optical system is placed between the projection mirror 36 and the projection mirror 37; however, this may be placed at any proper place between the DMD 33 and the screen 38, for example, between the projection mirror 37 and the screen 38.

Moreover, in the above-mentioned preferred embodiment, the first group lens system 5131 is provided with the beam regulator S; however, a diaphragm having a variable aperture diameter may be installed.

Furthermore, in the above-mentioned preferred embodiment, the distortion aberration and focal position on the screen surface are corrected by the oblique projection optical system; however, the oblique projection optical system may be arranged as an optical system that has functions for correcting only either the distortion aberration or the focal position.

While the invention has been shown and described in detail, the foregoing description is in all aspects illustrative and not restrictive. It is therefore understood that numerous other modifications and variations can be devised without departing from the scope of the invention.

What is claimed is:

1. A three-dimensional display apparatus comprising:
a screen;
a rotation mechanism for rotating said screen so as to volume-scan a predetermined space;
an image generation section for generating a cross-sectional image of a three-dimensional object to be displayed in response to a rotation of said rotation mechanism and for providing said cross-sectional image; and
a projection optical system for correcting distortion and out-of focus on a surface of said screen of said cross-sectional image provided from said image generation section, and for projecting said cross-sectional image to said screen that is rotating.

2. The three-dimensional display apparatus according to claim 1, wherein said projection optical system projects said cross-sectional image to said screen from a position that is rotated by said rotation mechanism while maintaining a positional relationship with said screen.

3. The three-dimensional display apparatus according to claim 2, wherein: said image generation section contains a face from which a cross-sectional image is given, and in said three-dimensional display apparatus, a line connecting a center of said face and a center of said surface of said screen is allowed to have any angle except for a right angle with respect to said surface of said screen.

4. The three-dimensional display apparatus according to claim 3, wherein said projection optical system includes a plurality of lenses, at least two lenses of said plurality of lenses being off-centered from each other.

5. The three-dimensional display apparatus according to claim 4, wherein none of said lenses are decentering lenses.

6. The three-dimensional display apparatus according to claim 3, wherein:
a normal to a surface of said screen and a principal ray of a center of an image projected onto said screen make a predetermined angle other than 0°; and
said projection optical system comprises a first lens group, a second lens group and a third lens group, each group having single lenses, that are placed in this order from said face side in succession, said first lens group being set within ±1° with respect to said face to form a telecentric structure, said second lens group having a decentration with respect to said first lens group, said second lens group having a decentration with respect to said third lens group.

7. The three-dimensional display apparatus according to claim 6, wherein a principal ray is tilted with respect to said normal with an angle of at least 35°.

8. The three-dimensional display apparatus according to claim 6, wherein said first lens group has a tilt decentration of within 1° and a parallel decentration of within 2 mm with respect to said face.

9. The three-dimensional display apparatus according to claim 5, wherein said first lens group includes a beam regulator.

10. An oblique projection optical system, which is arranged so that a line, which optically connects a center of a short conjugate length focal surface that is a focal surface on a short conjugate length side and a center of a long conjugate length focal surface that is a focal surface on a long conjugate length side, is allowed to have an angle other than vertical with respect to said long conjugate length focal surface, comprising:
a plurality of lenses, at least two of said plurality of lenses having a relative tilt decentration with each other.

11. The oblique projection optical system according to claim 10, wherein at least the two of said plurality of lenses further have a parallel decentration.

12. The oblique projection optical system according to claim 10, further comprising:
a first group lens system, a second group lens system and a third group lens system, each lens system having a plurality of single lenses with a common light axis in each lens system, that are placed in this order from a display surface side in succession,
said first group lens system being set within ±1° with respect to said short conjugate length focal surface to form a telecentric structure,
said second group lens system having a decentration with respect to said first group lens system,
said third group lens system having a decentration with respect to said second group lens system,
wherein a normal to said long conjugate length focal surface and a principal ray in a center of an image make a predetermined angle other than 0°.

13. The oblique projection optical system according to claim 12, wherein said predetermined angle is greater than 35°.

14. The oblique projection optical system according to claim 12, wherein said first group lens system has a tilt decentration of within 1° and a parallel decentration of within 2 mm with respect to said short conjugate length focal surface.

15. The oblique projection optical system according to claim 10, wherein said first group lens system includes a beam regulator.

16. The oblique projection optical system according to claim 12, wherein said second group lens system is tilted with an angle at least greater than −20 to 35° with respect to said first group lens system.

17. The oblique projection optical system according to claim 12, wherein said third group lens system is tilted with an angle at least greater than 30° with respect to said second group lens system.
